(19) United States
(12) Patent Application Publication
(10) Pub. No.: US 2026/0059353 A1
(43) Pub. Date: Feb. 26, 2026

(54) PROCESSING METHOD, COMMUNICATION DEVICE AND STORAGE MEDIUM

(71) Applicant: Shanghai Transsion Co., Ltd., Shanghai (CN)

(72) Inventor: Xingya SHEN, Shanghai (CN)

(73) Assignee: Shanghai Transsion Co., Ltd., Shanghai (CN)

(21) Appl. No.: 19/377,314

(22) Filed: Nov. 3, 2025

Related U.S. Application Data
(63) Continuation of application No. PCT/CN2023/092089, filed on May 4, 2023.

(51) Int. Cl. H04W 24/02

(52) U.S. Cl. CPC H04W 24/02

(57) ABSTRACT

A processing method includes: determining, via a terminal device, a number of reference symbols according to a first strategy. The number of reference symbols is configured to determine a transport block size. Through the technical solution of the present application, the terminal device can select different number of reference symbols for determining the transport block size according to the first strategy, thereby ensuring transmission efficiency.

### CROSS-REFERENCE TO RELATED APPLICATIONS

This application is a continuation application of International Application No. PCT/CN2023/092089, filed on May 4, 2023, the content of which is incorporated herein by reference in its entirety.

### TECHNICAL FIELD

The present application relates to the technical field of communication, and in particular to a processing method, a communication device and a storage medium.

### BACKGROUND

In the current specification, a terminal device determines whether a Physical Sidelink Feedback Channel (PSFCH) occasion will occur based on a pre-configured sidelink slot length to determine the number of available Resource Elements (REs), thereby determining Transport Block Size (TBS).

During the process of conceiving and implementing the present application, the inventors discovered: currently, SL-U supports two starting symbols in a sidelink slot, so the number of available REs in the sidelink slot is variable. In addition, if Physical Sidelink Shared Channel (PSSCH) transmission starts from the second starting symbol of the sidelink slot and the sidelink slot does not contain the PSFCH occasion, the number of available REs in the sidelink slot will also change. When the number of available REs for the PSSCH in the sidelink slot changes, if the terminal device determines the number of available REs only based on a pre-configured number of reference symbols, thereby determining the TB size, the TB size will not be adapted to the number of available REs in the sidelink slot. Therefore, rate matching is required, resulting in a lower code rate, wasted resources, and an inability to guarantee transmission efficiency. For example, if the pre-configured reference symbol is relatively large, but the terminal device starts transmission at the second starting symbol, the transmission block code rate will be higher, and the receiving terminal will not be able to correctly demodulate and decode; for another example, if the pre-configured reference symbol is relatively small, but the terminal device starts transmission at the first starting symbol, rate matching is required, resulting in a lower code rate and a waste of resources.

The preceding description is intended to provide general background information and does not necessarily constitute prior art.

### SUMMARY

The main objective of the present application is to provide a processing method, a communication device and a storage medium, aiming to propose a new technical solution for determining the number of reference symbols to solve the above-mentioned technical problem that the number of available REs is determined by the pre-configured number of reference symbols, and then the TB size is determined, which makes the TB size unable to adapt to the number of available REs in the sidelink slot.

The present application provides a processing method, which can be applied to a terminal device (such as a mobile phone), including the following steps:
S20: determining a number of target reference symbols, the number of target reference symbols being configured to determine a transport block size.

Optionally, the determining the number of target reference symbols includes at least one of the following:
when the transmission occurs outside a Channel Occupancy Time (COT), selecting, via the terminal device, a number of first reference symbols as the number of target reference symbols;
when the transmission occurs within the COT, selecting, via the terminal device, a number of second reference symbols as the number of target reference symbols;
when the transmission occurs outside the COT, determining, via the terminal device, the number of target reference symbols based on a second starting symbol and/or ending symbol; and
when the transmission occurs within the COT, determining, via the terminal device, the number of target reference symbols based on a first starting symbol and/or ending symbol.

Optionally, at least one of the following is further included:
at least one of the number of first reference symbols, the number of second reference symbols, the first starting symbol, the second starting symbol, the ending symbol, and the number of slot symbols is configured by a network device;
the terminal device is a receiving terminal, and at least one of the number of first reference symbols, the number of second reference symbols, the first starting symbol, the second starting symbol, the ending symbol, and the number of slot symbols is transmitted by a transmitting terminal;
the number of first reference symbols is less than or equal to the number of second reference symbols; and
the first starting symbol is earlier than or identical to the second starting symbol.

Optionally, the determining, via the terminal device, the number of target reference symbols based on the second starting symbol and/or ending symbol includes at least one of the following:
setting a number of symbols occupied by PSFCH to zero, determining, via the terminal device, the number of target reference symbols based on the second starting symbol and/or ending symbol, the number of slot symbols, and the number of symbols occupied by the PSFCH;
configuring a difference between the number of slot symbols and the second starting symbol as the number of target reference symbols; and
configuring a difference between the ending symbol and the second starting symbol as the number of target reference symbols.

Optionally, the method further includes:
determining the transport block size.

Optionally, the determining the transport block size includes at least one of the following:
determining the transport block size based on the number of target reference symbols;
when a terminal device attempts to transmit the PSSCH outside the COT, determining the transport block size based on a number of first reference symbols, a PSFCH overhead indicator, SL-CSI-RS overhead, and SL-PT-RS overhead configured by a network device;
when a terminal device attempts to transmit the PSSCH within the COT, determining the transport block size based on a number of second reference symbols, the PSFCH overhead indicator, the SL-CSI-RS overhead, and the SL-PT-RS overhead configured by the network device;
when a terminal device attempts to receive the PSSCH outside the COT, determining the transport block size based on the number of first reference symbols indicated by SCI and/or the PSFCH overhead indicator, the SL-CSI-RS overhead, and the SL-PT-RS overhead configured by the network device; and
when a terminal device attempts to receive the PSSCH within the COT, determining the transport block size based on a number of sidelink slot symbols, the PSFCH overhead indicator, the SL-CSI-RS overhead, and the SL-PT-RS overhead configured by the network device.

The present application further provides a processing method, including:
S10: transmitting configuration information, enabling a terminal device to determine a number of target reference symbols based on the configuration information, the number of target reference symbols being configured to determine a transport block size.

Optionally, the terminal device determining the number of target reference symbols based on the configuration information includes at least one of the following:
when the transmission occurs outside a Channel Occupancy Time (COT), selecting, via the terminal device, a number of first reference symbols as the number of target reference symbols;
when the transmission occurs within the COT, selecting, via the terminal device, a number of second reference symbols as the number of target reference symbols;
when the transmission occurs outside the COT, determining, via the terminal device, the number of target reference symbols based on a second starting symbol and/or ending symbol; and
when the transmission occurs within the COT, determining, via the terminal device, the number of target reference symbols based on a first starting symbol and/or ending symbol.

Optionally, the configuration information is transmitted by a network device or a transmitting device.

Optionally, the configuration information includes at least one of the following: at least two sets of number of reference symbols, a number of first reference symbols, a number of second reference symbols, a first starting symbol, a second starting symbol, an ending symbol, and the number of slot symbols.

The present application further provides a processing apparatus, including:
a determination module configured to determine a number of target reference symbols, the number of target reference symbols being configured to determine a transport block size.

The present application further provides a processing apparatus, including:
a transmitting module configured to transmit configuration information, enabling a terminal device to determine a number of target reference symbols based on the configuration information, the number of target reference symbols being configured to determine a transport block size.

The present application further provides a communications device, including: a memory, a processor, and a processing program stored in the memory and executable on the processor. When executed by the processor, the processing program implements any of the processing methods described above.

The communication device referred to in the present application may be a terminal device (e.g., a smart terminal, specifically a mobile phone) or a network device (e.g., a base station). The specific designation should be clarified based on the context.

The present application further provides a storage medium storing a computer program. When executed by the processor, the computer program implements the processing method described in any of the above embodiments.

Through the technical solution of the present application, the terminal device determines the number of target reference symbols, and the number of target reference symbols is configured to determine the transport block size, which allows the terminal device to select different number of reference symbols for determining the transport block size, thereby ensuring transmission efficiency.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of hardware structure of a mobile terminal that implements various embodiments of the present application.

FIG. 2 is a communication network system architecture diagram according to an embodiment of the present application.

FIG. 3 is a schematic diagram of hardware structure of a controller 140 involved in an embodiment of the processing method of the present application.

FIG. 4 is a schematic diagram of hardware structure of a network node 150 involved in an embodiment of the processing method of the present application.

FIG. 5 is a schematic diagram of the interaction flow between a terminal device and a network device in a first embodiment of the processing method of the present application.

FIG. 6 is a schematic diagram of determining a transport block size based on a number of first reference symbols and a number of second reference symbols in an embodiment of the present application.

FIG. 7 is a schematic diagram of the interaction flow between a terminal device and a network device in a fourth embodiment of the processing method of the present application.

The realization of the purpose, functional features and advantages of the present application will be further described in conjunction with the embodiments and with reference to the accompanying drawings. The above-mentioned drawings have shown clear embodiments of the present application, which will be described in more detail later. These drawings and textual descriptions are not intended to limit the scope of the concept of the present application in any way, but to illustrate the concept of the present application to those skilled in the art by referring to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S10 and S20 are used for the purpose of expressing the corresponding content more clearly and concisely, and do not constitute a substantial restriction on the order. When implementing the step, those skilled in the art may execute S20 first and then S10, etc., but these should all be within the scope of protection of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

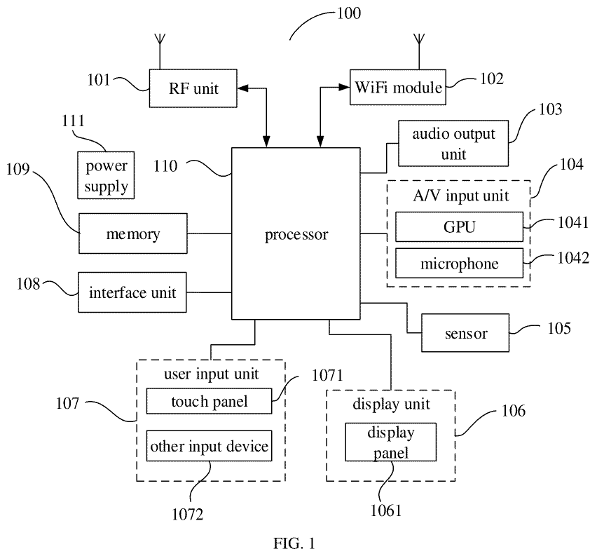

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or specification, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a denoting mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a denoting mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switch, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch location, detects the signal brought by the touch operation, and transmits the signal to the touch controller. The touch controller receives the touch information from the touch detection device, converts the touch information into contact coordinates, and transmits it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a BLUETOOTH module, or the like, which will not be repeated herein.

In order to facilitate the understanding of the embodiments of the present application, the following describes the communication network system on which the mobile terminal of the present application is based.

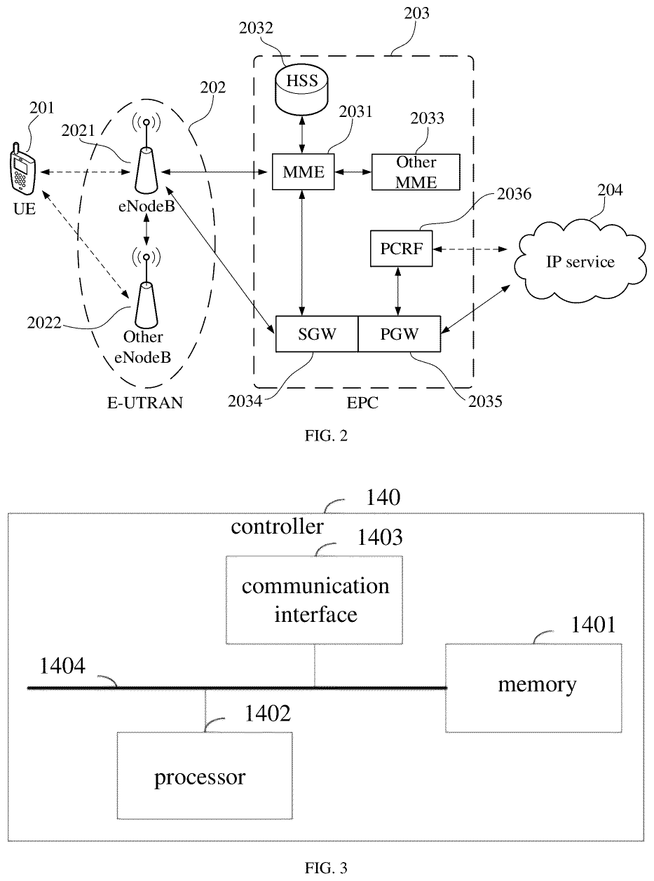

As shown in FIG. 2, FIG. 2 is a communication network system architecture diagram according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the above-mentioned mobile terminal hardware structure and communication network system, various embodiments of the present application are proposed.

FIG. 3 is a schematic diagram of hardware structure of a controller 140 provided in the present application. The controller 140 includes a memory 1401 and a processor 1402, the memory 1401 is configured to store program instructions, and the processor 1402 is configured to call the program instructions in the memory 1401 to execute the steps performed by the controller in the first embodiment of the above-mentioned method. The implementation principle and beneficial effects are similar and will not be repeated here.

Optionally, the above-mentioned controller also includes a communication interface 1403, which can be connected to the processor 1402 through a bus 1404. The processor 1402 can control the communication interface 1403 to realize the receiving and sending functions of the controller 140.

FIG. 4 is a schematic diagram of hardware structure of a network node 150 provided in the present application. The network node 150 includes a memory 1501 and a processor 1502. The memory 1501 is configured to store program instructions, and the processor 1502 is configured to call the program instructions in the memory 1501 to execute the steps performed by the first node in the first embodiment of the above method. The implementation principle and beneficial effects are similar and will not be repeated here.

Optionally, the above controller also includes a communication interface 1503, which can be connected to the processor 1502 through a bus 1504. The processor 1502 can control the communication interface 1503 to implement the receiving and sending functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

Technical terms used in the present application are as follows:
PSSCH: Physical Sidelink Shared Channel;
PSCCH: Physical Sidelink Control Channel;
Sidelink;
RE: Resource Element;
TB: Transmission Block;
TBS: Transmission Block Size;
COT: Channel Occupancy Time;
SCI: Sidelink Control Information.

### First Embodiment

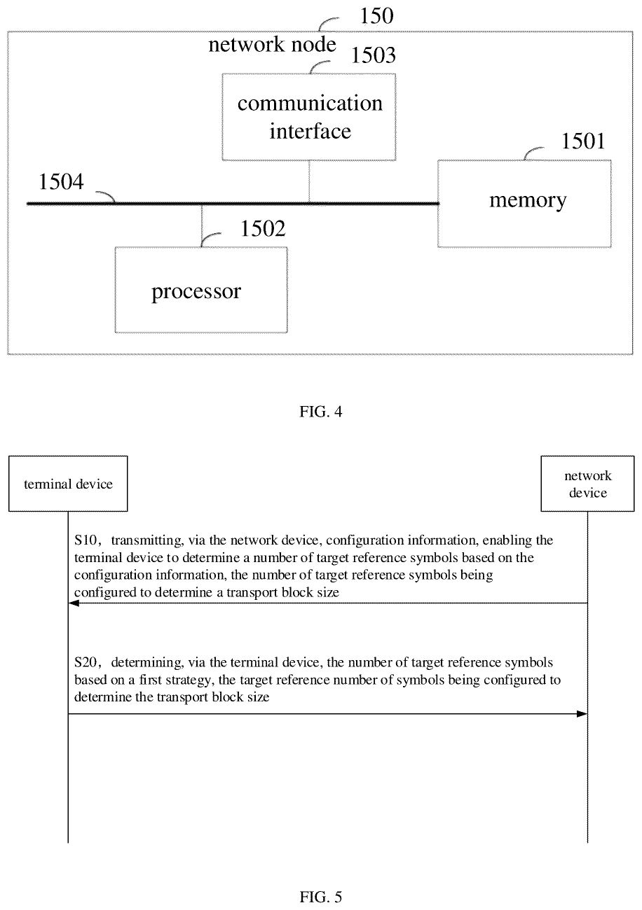

Referring to FIG. 5, the first embodiment of the present application provides a processing method, including the following steps:
S10: transmitting, via a network device, configuration information, enabling the terminal device to determine a number of target reference symbols based on the configuration information, the number of target reference symbols being configured to determine a transport block size; and
S20: determining, via the terminal device, the number of target reference symbols based on a first strategy, the number of target reference symbols being configured to determine the transport block size.

Optionally, the first strategy is associated with the configuration information.

Optionally, the terminal device determines the number of target reference symbols based on the configuration information, the number of target reference symbols being configured to determine the transport block size.

Optionally, the terminal device determines the number of target reference symbols based on the configuration information and the first strategy, the number of target reference symbols being configured to determine the transport block size.

Optionally, the network device transmits the configuration information, enabling the terminal device to determine the number of target reference symbols based on the configuration information, the number of target reference symbols being configured to determine the number of available resource elements, thereby determining the transport block size.

Optionally, the network device configures at least two sets of number of reference symbols for the transmitting terminal. The number of reference symbols are configured to determine the PSSCH transport block size. The two sets of number of reference symbols are used in different scenarios.

Optionally, the network device configures at least two sets of number of reference symbols for the transmitting terminal. The number of reference symbols are configured to determine the number of available resource elements and, thereby determining the PSSCH TB size. The two sets of number of reference symbols are used in different scenarios.

Optionally, as a scenario, the terminal device is the transmitting terminal. Before obtaining the COT, the transmitting terminal needs to prepare PSCCH and/or PSSCH in advance, and then perform LBT, that is, perform Type 1 channel access. Considering that the sidelink slot has two starting symbols, and different starting symbols will result in different numbers of available symbols in the sidelink slot for transmitting PSCCH and/or PSSCH, the transmitting terminal needs to transmit PSCCH and/or PSSCH after LBT succeeds. At this time, the transmitting terminal cannot adjust the transport block size again due to limited processing capability, so the transmitting terminal needs to select an appropriate number of reference symbols. For example, the transmitting terminal selects the number of first reference symbols as a parameter for calculating the transport block size.

Optionally, as another scenario, after the transmitting terminal obtains the COT, to ensure continuous transmission, the sidelink slot requires only one starting symbol. That is, within a COT, the number of available symbols in the sidelink slot is fixed. In this case, the transmitting terminal selects the number of second reference symbols as a parameter for calculating the transport block size.

Optionally, the configuration information is transmitted by the network device.

Optionally, the configuration information is transmitted by the transmitting terminal.

Optionally, the configuration information includes at least one of the following: at least two sets of number of reference symbols, a number of first reference symbols, a number of second reference symbols, a first starting symbol, a second starting symbol, an ending symbol, and the number of slot symbols.

Optionally, the determining the number of target reference symbols according to the first strategy includes at least one of the following:
when the transmission occurs outside the COT, selecting, via the terminal device, a number of first reference symbols as the number of target reference symbols;
when the transmission occurs within the COT, selecting, via the terminal device, a number of second reference symbols as the number of target reference symbols;
when the transmission occurs outside the COT, determining, via the terminal device, the number of target reference symbols based on a second starting symbol and/or ending symbol;
when the transmission occurs within the COT, determining, via the terminal device, the number of target reference symbols based on a first starting symbol and/or ending symbol.

Optionally, at least one of the number of first reference symbols, the number of second reference symbols, the first starting symbol, the second starting symbol, the ending symbol, and the number of slot symbols is configured by a network device.

Optionally, the terminal device is a receiving terminal, and at least one of the number of first reference symbols, the number of second reference symbols, the first starting symbol, the second starting symbol, the ending symbol, and the number of slot symbols is transmitted by a transmitting terminal.

Optionally, at least one of the number of first reference symbols, the number of second reference symbols, the first starting symbol, the second starting symbol, the ending symbol, and the number of slot symbols is carried in an SCI and/or a sidelink RRC, and the SCI and/or the sidelink RRC is transmitted by the transmitting terminal.

Optionally, the number of first reference symbols is less than or equal to the number of second reference symbols.

Optionally, the first starting symbol is earlier than or identical to the second starting symbol.

Optionally, determining, via the terminal device, the number of target reference symbols based on the first starting symbol and/or the ending symbol includes at least one of the following:
configuring a difference between the number of slot symbols and the second starting symbol as the number of target reference symbols;
configuring a difference between the ending symbol and the second starting symbol as the number of target reference symbols.

Optionally, determining, via the terminal device, the number of target reference symbols based on the second starting symbol and ending symbol includes at least one of the following:
setting a number of symbols occupied by the PSFCH to zero, determining, via the terminal device, the number of target reference symbols based on the second starting symbol and/or ending symbol, the number of slot symbols, and the number of symbols occupied by the PSFCH;
configuring the difference between the number of slot symbols and the second starting symbol as the number of target reference symbols; and
configuring the difference between the ending symbol and the second starting symbol as the number of target reference symbols.

Optionally, before transmission, the transmitting terminal performs a channel access procedure, such as performing a Type 1 channel access procedure, namely, performing LBT. If the terminal successfully performs LBT and it is the first transmission, the transmitting terminal may be considered to have occupied the channel, i.e., the transmitting terminal has initiated the COT.

Optionally, the transmission occurring outside the COT means that the transmitting terminal has not yet occupied the channel, or in other words, has not yet initiated the COT, when preparing to perform the transmission.

Optionally, the transmission occurring outside the COT means that the transmitting terminal performs LBT for the transmission and upon successful LBT, initiates the COT. Such a transmission that initiates the COT is considered to be the transmission occurring outside the COT.

Optionally, the transmission occurring within the COT means that the transmission occurs in a slot within the COT. For example, the transmission occurs in a slot of the COT other than the first slot.

Optionally, the transmission occurring within the COT means that the transmitting terminal obtains a COT after a successful LBT, and then transmits in some slots included in the COT, wherein these slots are slots of the COT other than the first slot.

Optionally, the method further includes determining a transport block size based on a second strategy.

Optionally, the determining the transport block size based on the second strategy includes at least one of the following:
determining the number of available resource elements based on the number of target reference symbols, thereby determining the transport block size;
when the terminal device attempts to transmit the PSSCH outside the COT, determining the number of available resource elements based on the number of first reference symbols, PSFCH overhead indication, SL-CSI-RS overhead, and SL-PT-RS overhead configured by the network device, thereby determining the transport block size;
when the terminal device attempts to transmit the PSSCH within the COT, determining the number of available resource elements according to the number of second reference symbols, PSFCH overhead indication, SL-CSI-RS overhead, and SL-PT-RS overhead configured by the network device, thereby determining the transport block size;
when the terminal device attempts to receive the PSSCH outside the COT, determining the number of available resource elements based on the number of first reference symbols indicated by the SCI and/or the PSFCH overhead indication, SL-CSI-RS overhead, and SL-PT-RS overhead configured by the network device, thereby determining the transport block size;
when the terminal device attempts to receive the PSSCH within the COT, determining the number of available resource elements based on the number of sidelink slot symbols, PSFCH overhead indication, SL-CSI-RS overhead, and SL-PT-RS overhead configured by the network device, thereby determining the transport block size.

The terminal device calculates a temporary number of information bits based on the number of available resource elements, the number of layers, the modulation order and code rate determined by the MCS. Based on the comparison of the temporary number of information bits with a threshold, the terminal device determines whether the transport block size is obtained through table look-up or formula calculation.

Optionally, the number of available resource elements is determined by the number of first reference symbols and the number of second reference symbols, so that the transport block size is determined as shown in FIG. 6.

In the technical solution of this embodiment, the terminal device determines the number of target reference symbols based on configuration information and/or the first strategy. The number of target reference symbols is configured to determine the transport block size. This allows the terminal device to select different number of reference symbols for determining the transport block size based on the configuration information and/or the first strategy, thereby ensuring transmission efficiency.

### Second Embodiment

Based on the above embodiments, the second embodiment of the present application provides a processing method, using a terminal device as a transmitting terminal. Specifically, the transmitting terminal selects different number of reference symbols according to a first strategy to determine the number of available resource elements, thereby determining the transport block size and ensuring transmission efficiency.

In this embodiment, the network device transmits configuration information enabling the terminal device to determine a number of target reference symbols according to the first strategy. The first strategy is associated with the configuration information. The number of target reference symbols is configured to determine the number of available resource elements, thereby determining the transport block size.

Optionally, the configuration information is transmitted by the network device.

Optionally, the configuration information is transmitted by the transmitting terminal.

Optionally, the configuration information includes at least one of the following: at least two sets of number of reference symbols, a number of first reference symbols, a number of second reference symbols, a first starting symbol, a second starting symbol, an ending symbol, and the number of slot symbols.

Optionally, the network device configures at least two sets of number of reference symbols for the transmitting terminal. The number of reference symbols are configured to determine the number of available resource elements, thereby determining the PSSCH transport block size. The two sets of number of reference symbols are used in different scenarios.

Optionally, the at least two sets of number of reference symbols configured by the network device for the transmitting terminal is provided by higher-layer signaling and may be selected from {7, 8, 9, 10, 11, 12, 13, 14}.

Optionally, the higher-layer signaling is carried in an RRC message.

Optionally, the higher-layer signaling is carried in a MAC CE.

Optionally, the number of reference symbols is predefined in the specification and may be selected from {7, 8, 9, 10, 11, 12, 13, 14}.

Optionally, the transmitting terminal indicates the number of reference symbols to the receiving terminal, and the number may be selected from {7, 8, 9, 10, 11, 12, 13, 14}. The indication is carried in a sidelink RRC message.

Optionally, the indication is carried in the SCI.

Optionally, as a scenario, before obtaining COT, the transmitting terminal needs to prepare PSCCH and/or PSSCH in advance, and then perform LBT, that is, perform Type 1 channel access.

Given that the sidelink slot has two starting symbols, and different starting symbols result in different numbers of available symbols in the sidelink slot, the transmitting terminal needs to transmit the PSCCH and/or PSSCH after LBT is successful. Due to processing power limitations, the transmitting terminal cannot easily adjust the transport block size again. Therefore, the transmitting terminal needs to select an appropriate number of reference symbols. For example, the transmitting terminal selects the number of first reference symbols as a parameter for calculating the transport block size.

Optionally, determining, via the terminal device, the number of target reference symbols based on a first strategy includes at least one of the following:
when the transmission occurs outside the COT, selecting, via the terminal device, the number of first reference symbols as the number of target reference symbols;
when the transmission occurs within the COT, selecting, via the terminal device, the number of second reference symbols as the number of target reference symbols;
when the transmission occurs outside the COT, determining, via the terminal device, the number of target reference symbols based on a second starting symbol and/or ending symbol; and
when the transmission occurs within the COT, determining, via the terminal device, the number of target reference symbols based on a first starting symbol and/or ending symbol.

Optionally, at least one of the number of first reference symbols, the number of second reference symbols, the first starting symbol, the second starting symbol, the ending symbol, and the number of slot symbols is configured by the network device.

Optionally, the first starting symbol configured by the network device for the transmitting terminal is provided by higher-layer signaling and can be selected from {0, 1, 2, 3, 4, 5, 6, 7}.

Optionally, the higher-layer signaling is carried in an RRC message.

Optionally, the higher-layer signaling is carried in a MAC CE.

Optionally, the first starting symbol is predefined in the specification and can be selected from {0, 1, 2, 3, 4, 5, 6, 7}.

Optionally, if the first starting symbol is not configured, the first starting symbol defaults to symbol 0.

Optionally, the second starting symbol configured by the network device for the transmitting terminal is provided by higher-layer signaling and can be selected from {3, 4, 5, 6, 7}.

Optionally, the higher-layer signaling is carried in an RRC message.

Optionally, the higher-layer signaling is carried in a MAC CE.

Optionally, the second starting symbol is predefined in the specification and can be selected from {3, 4, 5, 6, 7}.

Optionally, the ending symbol configured by the network device for the transmitting terminal is provided by higher-layer signaling and can be selected from {6, 7, 8, 9, 10, 11, 12, 13}.

Optionally, the higher-layer signaling is carried in an RRC message.

Optionally, the higher-layer signaling is carried in a MAC CE.

Optionally, the ending symbol is predefined in the specification and can be selected from {6, 7, 8, 9, 10, 11, 12, 13}.

Optionally, the number of slot symbols is provided by a higher-layer parameter and can be selected from {7, 8, 9, 10, 11, 12, 13, 14}.

Optionally, the number of slot symbols is predefined in the specification and can be selected from {7, 8, 9, 10, 11, 12, 13, 14}.

Optionally, the transmitting terminal indicates the number of first reference symbols to the receiving terminal via the SCI and uses the number of first reference symbols as the number of target reference symbols, and the number of target reference symbols is used as a parameter for calculating the transport block size.

Optionally, the number of first reference symbols can be selected from {7, 8, 9, 10, 11, 12, 13, 14}.

Optionally, the transmitting terminal determines the number of target reference symbols based on the second starting symbol and the ending symbol, and the number of target reference symbols is used as a parameter for calculating the transport block size.

Optionally, the transmitting terminal configures the difference between the ending symbol and the second starting symbol as the number of target reference symbols.

Optionally, the transmitting terminal configures the value obtained by adding 1 to the difference between the ending symbol and the second starting symbol as the number of target reference symbols.

Optionally, if the transmitting terminal determines the number of target reference symbols based on the second starting symbol and ending symbol, the transmitting terminal sets the number of symbols occupied by the PSFCH to zero.

Optionally, if the transmitting terminal transmits the physical sidelink control channel and/or physical sidelink data channel corresponding to the transmission on the second starting symbol, the transmitting terminal sets the number of symbols occupied by the PSFCH to zero, i.e., N_{symb}^{PSFCH}=0.

Optionally, the transmitting terminal indicates the second starting symbol and/or ending symbol to the receiving terminal via SCI.

Optionally, the transmitting terminal indicates the second starting symbol and/or ending symbol to the receiving terminal via sidelink RRC signaling.

Optionally, the network device configures the second starting symbol and/or ending symbol for the receiving terminal via RRC signaling.

Optionally, the second starting symbol value may be selected from {3, 4, 5, 6, 7}.

Optionally, the ending symbol value may be selected from {6, 7, 8, 9, 10, 11, 12, 13}.

Optionally, the second starting symbol is predefined in the specification and its value may be selected from {3, 4, 5, 6, 7}.

Optionally, the ending symbol is predefined in the specification and its value may be selected from {6, 7, 8, 9, 10, 11, 12, 13}.

Optionally, before transmission, the transmitting terminal performs a channel access procedure, such as performing a Type 1 channel access procedure, namely, performing LBT. If the terminal successfully performs LBT and it is the first transmission, the transmitting terminal may be considered to have occupied the channel, i.e., the transmitting terminal has initiated the COT.

Optionally, the transmission occurring outside the COT means that the transmitting terminal has not yet occupied the channel, or in other words, has not yet initiated the COT, when preparing to perform the transmission.

Optionally, the transmission occurring outside the COT means that the transmitting terminal performs LBT for the transmission and upon successful LBT, initiates the COT. Such a transmission that initiates the COT is considered to be the transmission occurring outside the COT.

Optionally, the transmission occurring within the COT means that the transmission occurs in a slot within the COT. For example, the transmission occurs in a slot of the COT other than the first slot.

Optionally, the transmission occurring within the COT means that the transmitting terminal obtains the COT after a successful LBT, and then transmits in some slots included in the COT, wherein these slots are slots of the COT other than the first slot.

Optionally, the transmitting terminal indicates COT information via sidelink control information. The COT information includes at least one of the following:
remaining COT duration,
COT length in units of slots,
uplink/downlink pattern in the time domain, and
resource block set index.

Optionally, the COT start time is the slot in which the sidelink control information carrying the COT information is located.

Optionally, the COT location in the time domain is determined using the COT start time and the COT information. By determining the COT location in the time domain and the location of the transmission in the time domain, it is possible to determine whether the transmission occurs within or outside the COT.

Optionally, as another scenario, after the transmitting terminal obtains the COT, to ensure continuous transmission, the sidelink slot requires only one starting symbol. That is, within a COT, the number of available symbols in the sidelink slot is fixed.

Optionally, the transmitting terminal selects a number of second reference symbols as a number of target reference symbols, and the number of target reference symbols is used as a parameter for calculating the transport block size.

Optionally, the transmitting terminal indicates the number of second reference symbols to the receiving terminal via the SCI.

Optionally, the transmitting terminal indicates the number of second reference symbols to the receiving terminal via a sidelink RRC message.

Optionally, the network device indicates the number of second reference symbols to the receiving terminal via an RRC message.

Optionally, the number of second reference symbols is determined by the IE ‘sl-LengthSymbols’.

Optionally, the number of second reference symbols may be selected from {7, 8, 9, 10, 11, 12, 13, 14}.

Optionally, the transmitting terminal determines the number of target reference symbols based on the first starting symbol and ending symbol, and uses the number of target reference symbols as a parameter for calculating the transport block size.

Optionally, the transmitting terminal determines the number of target reference symbols based on the first starting symbol and/or ending symbol and the number of slot symbols, and uses the number of target reference symbols as a parameter for calculating the transport block size.

Optionally, the transmitting terminal configures the difference between the number of slot symbols and the first starting symbol as the number of target reference symbols.

Optionally, the transmitting terminal configures the difference between the ending symbol and the first starting symbol as the number of target reference symbols.

Optionally, the transmitting terminal configures the value obtained by adding 1 to the difference between the ending symbol and the second starting symbol as the number of target reference symbols.

Optionally, the transmitting terminal indicates the first starting symbol and/or ending symbol to the receiving terminal via SCI.

Optionally, the transmitting terminal indicates the first starting symbol and/or ending symbol to the receiving terminal via sidelink RRC signaling.

Optionally, the network device configures the first starting symbol and/or ending symbol for the receiving terminal via RRC signaling.

Optionally, the first starting symbol may be selected from {0, 1, 2, 3, 4, 5, 6, 7}.

Optionally, the ending symbol may be selected from {6, 7, 8, 9, 10, 11, 12, 13}.

Optionally, the number of slot symbols may be selected from {7, 8, 9, 10, 11, 12, 13, 14}.

Optionally, the first starting symbol is predefined in the specification and its value may be selected from {0, 1, 2, 3, 4, 5, 6, 7}.

Optionally, the ending symbol is predefined in the specification and its value may be selected from {6, 7, 8, 9, 10, 11, 12, 13}.

Optionally, the number of slot symbols is predefined in the specification and its value may be selected from {7, 8, 9, 10, 11, 12, 13, 14}.

Optionally, when attempting to transmit the PSSCH outside the COT, the transmitting terminal determines the transmission block size based on parameters such as the number of first reference symbols, PSFCH overhead indication, SL-CSI-RS overhead, and SL-PT-RS overhead configured by the network device.

Optionally, when attempting to transmit the PSSCH within the COT, the transmitting terminal determines the transport block size based on parameters configured by the network device, such as the number of second reference symbols, PSFCH overhead indicator, SL-CSI-RS overhead, and SL-PT-RS overhead.

Optionally, the transmitting terminal first determines the number of REs available for PSSCH transmission within one resource block in a sidelink slot.

Optionally, the transmitting terminal determines the number of REs that can be used to transmit the PSSCH within one resource block in a sidelink slot based on parameters such as the number of subcarriers and/or the number of reference symbols and/or the number of PSFCH symbols and/or the SL-CSI-RS overhead and/or the SL-PT-RS overhead and/or the SL DMRS overhead in a resource block.

Optionally, the relationship among the parameters can be shown in the following formula (1):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 1 )$$

Optionally,

$${N}_{sc}^{RB} = 12$$

represents the number of subcarriers in a resource block.

Optionally,

$${N}_{oh}^{PRB}$$

represents the SL-CSI-RS overhead and SL-PT-RS overhead; this parameter is provided by the RRC parameter IE ‘sl-X-Overhead’.

Optionally,

$${N}_{RE}^{DMRS}$$

represents the SL DMRS overhead; this parameter is determined by the RRC parameter IE ‘l-PSSCH-DMRS-TimePatternList’ and as shown in Table 1 below.

TABLE 1
${N}_{RE}^{DMRS} according to the higher - layer parameter$
sl-PSSCH-DMRS-TimePatternList

| sl-PSSCH-DMRS-TimePatternList | ${N}_{RE}^{DMRS}$ |
|---|---|
| {2} | 12 |
| {3} | 18 |
| {4} | 24 |
| {2, 3} | 15 |
| {2, 4} | 18 |
| {3, 4} | 21 |
| {2, 3, 4} | 18 |

Optionally, when the higher-layer parameter IE ‘sl-PSFCH-Period’ configures the PSFCH period to 2 or 4, if SCI format 1-A indicates the presence of PSFCH overhead,

$${N}_{symb}^{PSFCH} = 3 ;$$

and/or, if SCI format 1-A indicates the absence of PSFCH overhead,

$${N}_{symb}^{PSFCH} = 0.$$

Optionally, when the higher-layer parameter IE ‘sl-PSFCH-Period’ configures the PSFCH period to 1,

$${N}_{symb}^{PSFCH} = 3 .$$

Optionally, when the higher-layer parameter IE ‘sl-PSFCH-Period’ configures the PSFCH period to 0,

$${N}_{symb}^{PSFCH} = 0 .$$

Optionally, when the PSCCH and PSSCH that the transmitting terminal attempts to transmit are outside the COT, N_{symb}^{sh} is the number of first reference symbols, and its value can be selected from {7, 8, 9, 10, 11, 12, 13, 14}.

Optionally, the number of first reference symbols is carried in an RRC message and configured by the network device.

Optionally, the number of first reference symbols is predefined in the specification.

Optionally, when the PSCCH and PSSCH that the transmitting terminal attempts to transmit are outside the COT,

$${N}_{symb}^{sh}$$

is determined by the second starting symbol and ending symbol.

Optionally, when the PSCCH and PSSCH that the transmitting terminal attempts to transmit are outside the COT,

$${N}_{symb}^{sh}$$

is determined by the second starting symbol and/or ending symbol and the number of slot symbols.

Optionally, the difference between the number of slot symbols and the second starting symbol is used as the number of reference symbols.

Optionally, the difference between the ending symbol and the second starting symbol is used as the number of target reference symbols.

Optionally, the value obtained by adding 1 to the difference between the ending symbol and the second starting symbol is used as the number of target reference symbols.

Optionally, the value of the second starting symbol can be selected from {3, 4, 5, 6, 7}.

Optionally, the second starting symbol is carried in an RRC message and configured by a network device.

Optionally, the second starting symbol is predefined in the specification.

Optionally, the value of the ending symbol can be selected from {6, 7, 8, 9, 10, 11, 12,

13}.

Optionally, the ending symbol is carried in an RRC message and configured by a network device.

Optionally, the ending symbol is predefined in the specification.

Optionally, the value of the number of slot symbols can be selected from {7, 8, 9, 10, 11, 12, 13, 14}.

Optionally, the number of slot symbols is carried in an RRC message and configured by the network device.

Optionally, the number of slot symbols is predefined in the specification.

Optionally, if the transmitting terminal determines the number of reference symbols based on the second starting symbol and ending symbol, the transmitting terminal sets the number of symbols occupied by the PSFCH to zero, that is,

$${N}_{symb}^{PSFCH} = 0 .$$

Optionally, if the transmitting terminal transmits the physical sidelink data channel and/or the physical sidelink data channel starting from the second starting symbol, the transmitting terminal sets the number of symbols occupied by the PSFCH to zero, that is,

$${N}_{symb}^{PSFCH} = 0 .$$

Optionally, when the PSCCH and PSSCH that the transmitting terminal attempts to transmit are within the COT,

$${N}_{symb}^{sh}$$

is the number of second reference symbols, which can be selected from {7, 8, 9, 10, 11, 12, 13, 14}.

Optionally, the number of second reference symbols is carried in an RRC message and configured by the network device.

Optionally, the number of second reference symbols is predefined in the specification.

Optionally, when the PSCCH and PSSCH that the transmitting terminal attempts to transmit are within the COT,

$${N}_{symb}^{sh}$$

is determined by the first starting symbol and ending symbol.

Optionally, when the PSCCH and PSSCH that the transmitting terminal attempts to transmit are within the COT,

$${N}_{symb}^{sh}$$

is determined by the first starting symbol and/or ending symbol and the number of symbols in the slot.

Optionally, the difference between the number of slot symbols and the first starting symbol is used as the number of target reference symbols.

Optionally, the difference between the ending symbol and the first starting symbol is used as the number of target reference symbols.

Optionally, the value obtained by adding 1 to the difference between the ending symbol and the second starting symbol is used as the number of target reference symbols.

Optionally, the value of the first starting symbol can be selected from {0, 1, 2, 3, 4, 5, 6, 7}.

Optionally, the first starting symbol is carried in an RRC message and configured by the network device.

Optionally, the first starting symbol is predefined in the specification.

Optionally, the value of the ending symbol can be selected from {6, 7, 8, 9, 10, 11, 12, 13}.

Optionally, the ending symbol is carried in an RRC message and configured by the network device.

Optionally, the ending symbol is predefined in the specification.

Optionally, the number of slot symbols can be selected from {7, 8, 9, 10, 11, 12, 13, 14}.

Optionally, the number of slot symbols is carried in an RRC message and configured by the network device.

Optionally, the number of slot symbols is predefined in the specification.

Optionally,

$${N}_{symb}^{sh}$$

is the number of available symbols for PSSCH transmission in a sidelink slot, provided by a higher-layer parameter, for example, from the IE ‘sl-LengthSymbols’. Its value can be selected from {7, 8, 9, 10, 11, 12, 13, 14}.

Optionally, the transmitting terminal determines the total number N_{RE} of resource elements available for PSSCH transmission in a sidelink slot.

Optionally, the transmitting terminal determines the total number of resource elements available for PSSCH transmission in a sidelink slot based on the total number of resource elements available for PSSCH transmission within one resource block in a sidelink slot, the number of resource elements occupied by the PSCCH and PSCCH DMRS, and the number of coded modulation symbols used for two-stage SCI transmission.

Optionally, the relationship between the parameters is as shown in the following formula (2):

$${N}_{RE} = {N}_{RE}^{′} \cdot {n}_{PRB} - {N}_{RE}^{SCI , 1} - {N}_{RE}^{SCI , 2} \qquad ( 2 )$$

N_{RE} is the total number of resource elements available for PSSCH transmission in a sidelink slot.

$${N}_{RE}^{′}$$

is the total number of resource elements available for PSSCH transmission within one resource block in a sidelink slot.

n_{PRB} is the total number of resource blocks available for PSSCH transmission.

$${N}_{RE}^{SCI , 1}$$

is the number of resource elements occupied by PSCCH and PSCCH DMRS.

$${N}_{RE}^{SCI , 2}$$

is the number of coded modulation symbols used for two-stage SCI transmission.

Step 2: The number of non-quantized temporary information bits N_{info} is obtained by the following formula (3):

$${N}_{info} = {N}_{RE} \cdot R \cdot {Q}_{m} \cdot v \qquad ( 3 )$$

N_{RE} is the total number of resource elements available for PSSCH transmission in a sidelink slot.

R is the target code rate.

Qₘ is the modulation order.

v is the number of layers.

Optionally, when N_{info}≤3824, N_{info} is first quantized to obtain N_{info′}, that is

$${N}_{info}^{′} = max ( 24 , {2}^{n} \cdot ⌊ \frac{{N}_{info}}{{2}^{n}} ⌋ ) .$$

n=max(3, └log₂(N_{info})┘−6). From Table 2 below, find the value closest to and less than or equal to N_{info′} as the transport block size.

TABLE 2
the transport block size, when N_{info} ≤ 3824

| index | transport block size |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |
| — | — |

Optionally, when N_{info}>3824, the transport block size is calculated using the following formula (4):

Optionally, N_{info} is first quantized to obtain N_{info′}, i.e.

$${N}_{info}^{′} = max ( 3840 , {2}^{n} \times round ( \frac{{N}_{info} - 24}{{2}^{n}} ) ) \qquad ( 4 )$$

where n=└log₂(N_{info}−24)┘−5

Then, the following formula is used to calculate the transport block size.

Optionally, if

$$R \leq 1 / 4 , then TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{3816} ⌉ .$$

Optionally, if R>¼ and N_{info′}>8424, then

$$TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{8424} ⌉ .$$

Optionally, if R>¼ and N_{info′}≤8424, then

$$TBS = 8 \cdot ⌈ \frac{{N}_{info}^{′} + 24}{8} ⌉ - 24 .$$

In technical solution of this embodiment, the transmitting terminal determines the number of target reference symbols according to the first strategy, and the number of target reference symbols is configured to determine the transmission block size. Specifically, the transmitting terminal can select different number of reference symbols to determine the transmission block size according to whether the PSSCH transmitted by the transmitting terminal is outside or within the COT, thereby ensuring the transmission efficiency.

### Third Embodiment

Based on any one of the above embodiments, the third embodiment of the present application proposes a processing method, taking the terminal device as the receiving terminal, and specifically explains that the receiving terminal selects different number of reference symbols according to the first strategy to determine the number of available resource elements, and then determines the transmission block size, thereby ensuring transmission efficiency.

In this embodiment, the network device transmits the configuration information to enable a terminal device to determine the number of target reference symbols based on the configuration information. The number of target reference symbols is configured to determine the number of available resource elements, thereby determining the transport block size.

The terminal device determines the number of target reference symbols based on a first strategy. The number of target reference symbols is configured to determine the number of available resource elements, thereby determining the transport block size. The first strategy is associated with the configuration information.

Optionally, determining the number of target reference symbols according to the first strategy includes at least one of the following:
when the transmission occurs outside the COT, the terminal device selecting a number of first reference symbols as the number of target reference symbols;
when the transmission occurs within the COT, the terminal device selecting a number of second reference symbols as the number of target reference symbols;
when the transmission occurs outside the COT, the terminal device determining the number of target reference symbols based on a second starting symbol and/or ending symbol;
when the transmission occurs within the COT, the terminal device determining the number of target reference symbols based on a first starting symbol and/or ending symbol.

Optionally, at least one of the number of first reference symbols, the number of second reference symbols, the first starting symbol, the second starting symbol, the ending symbol, and the number of slot symbols is configured by the network device.

Optionally, the first starting symbol configured by the network device for the receiving terminal is provided by higher-layer signaling and can be selected from {0, 1, 2, 3, 4, 5, 6, 7}.

Optionally, the higher-layer signaling is carried in an RRC message.

Optionally, the higher-layer signaling is carried in a MAC CE.

Optionally, the first starting symbol is predefined in the specification and can be selected from {0, 1, 2, 3, 4, 5, 6, 7}.

Optionally, if the first starting symbol is not configured, the first starting symbol defaults to symbol 0.

Optionally, the second starting symbol configured by the network device for the transmitting terminal is provided by higher-layer signaling and can be selected from {3, 4, 5, 6, 7}.

Optionally, the higher-layer signaling is carried in an RRC message.

Optionally, the higher-layer signaling is carried in a MAC CE.

Optionally, the second starting symbol is predefined in the specification and can be selected from {3, 4, 5, 6, 7}.

Optionally, the ending symbol configured by the network device for the transmitting terminal is provided by higher-layer signaling and can be selected from {6, 7, 8, 9, 10, 11, 12, 13}.

Optionally, the higher-layer signaling is carried in an RRC message.

Optionally, the higher-layer signaling is carried in a MAC CE.

Optionally, the ending symbol is predefined in the specification and its value can be selected from {6, 7, 8, 9, 10, 11, 12, 13}.

Optionally, the number of slot symbols configured by the network device for the transmitting terminal is provided by higher-layer signaling and can be selected from {7, 8, 9, 10, 11, 12, 13, 14}.

Optionally, the higher-layer signaling is carried in an RRC message.

Optionally, the higher-layer signaling is carried in a MAC CE.

Optionally, the number of slot symbols is predefined in the specification and its value can be selected from {7, 8, 9, 10, 11, 12, 13, 14}.

Optionally, at least one of the number of first reference symbols, the number of second reference symbols, the first starting symbol, the second starting symbol, the ending symbol, and the number of slot symbols is transmitted by the transmitting terminal.

Optionally, at least one of the number of first reference symbols, the number of second reference symbols, the first starting symbol, the second starting symbol, the ending symbol, and the number of slot symbols to be transmitted by the transmitting terminal is carried in the SCI and/or in the sidelink RRC.

Optionally, the first starting symbol transmitted by the transmitting terminal may be selected from {0, 1, 2, 3, 4, 5, 6, 7}.

Optionally, the first starting symbol is predefined in the specification and its value may be selected from {0, 1, 2, 3, 4, 5, 6, 7}.

Optionally, the second starting symbol transmitted by the transmitting terminal may be selected from {3, 4, 5, 6, 7}.

Optionally, the second starting symbol transmitted by the transmitting terminal is predefined in the specification and can be selected from {3, 4, 5, 6, 7}.

Optionally, the ending symbol transmitted by the transmitting terminal can be selected from {6, 7, 8, 9, 10, 11, 12, 13}.

Optionally, the ending symbol is predefined in the specification and can be selected from {6, 7, 8, 9, 10, 11, 12, 13}.

Optionally, the number of slot symbols is provided by a higher-layer parameter and can be selected from {7, 8, 9, 10, 11, 12, 13, 14}.

Optionally, the number of slot symbols is predefined in the specification and can be selected from {7, 8, 9, 10, 11, 12, 13, 14}. Optionally, the number of slot symbols is provided by a higher-layer parameter, and its value can be selected from {7, 8, 9, 10, 11, 12, 13, 14}.

Optionally, the number of slot symbols is predefined in the specification, and its value can be selected from {7, 8, 9, 10, 11, 12, 13, 14}.

Optionally, before transmission, the transmitting terminal performs a channel access procedure, such as performing a Type 1 channel access procedure, namely, performing LBT. If the terminal successfully performs LBT and it is the first transmission, the transmitting terminal may be considered to have occupied the channel, i.e., the transmitting terminal has initiated the COT.

Optionally, the transmission occurring outside the COT means that the transmitting terminal has not yet occupied the channel, or in other words, has not yet initiated the COT, when preparing to perform the transmission.

Optionally, the transmission occurring outside the COT means that the transmitting terminal performs LBT for the transmission and upon successful LBT, initiates the COT. Such a transmission that initiates the COT is considered to be the transmission occurring outside the COT.

Optionally, the transmission occurring outside the COT means that the receiving terminal does not receive COT information, that is, the receiving terminal cannot determine whether the transmitting terminal has obtained the COT.

Optionally, the transmission occurring within the COT means that the transmission occurs in a slot within the COT. For example, the transmission occurs in a slot of the COT other than the first slot.

Optionally, the transmission occurring within the COT means that the receiving terminal obtains COT information, for example, the time information of the COT, and then receives the transmission within some slots included in this COT, wherein these slots are slots of the COT other than the first slot.

Optionally, the receiving terminal receives sidelink control information transmitted by the transmitting terminal and obtains COT information indicated by the sidelink control information. The COT information includes at least one of the following:
remaining COT duration,
COT length in units of slots,
uplink/downlink pattern in the time domain, and
resource block set index.

Optionally, the COT start time is the slot in which the sidelink control information carrying the COT information is located.

Optionally, the COT start time and the COT information are used to determine the time domain location of the COT. By determining the time domain location of the COT and the time domain location of the transmission, it can be determined whether the transmission occurs within the COT or outside the COT.

Optionally, when the receiving terminal attempts to receive the PSSCH outside the COT, the receiving terminal determines the number of available resource elements based on the number of first reference symbols indicated by the SCI, thereby determining the transport block size.

Optionally, the receiving terminal determines the number of available resource elements based on the number of first reference symbols indicated by the network device, thereby determining the transport block size.

Optionally, the receiving terminal determines the number of available resource elements based on the number of first reference symbols indicated by the transmitting terminal, thereby determining the transport block size.

Optionally, the indication is carried in a sidelink RRC message.

Optionally, the number of first reference symbols may be selected from {7, 8, 9, 10, 11, 12, 13, 14}.

Optionally, the receiving terminal determines the number of target reference symbols based on the second starting symbol and ending symbol, and the number of target reference symbols is used as a parameter for calculating the transport block size.

Optionally, the receiving terminal determines the number of target reference symbols based on the second starting symbol and/or ending symbol and the number of slot symbols, and the number of target reference symbols is used as a parameter for calculating the transport block size.

Optionally, the receiving terminal configures the difference between the number of slot symbols and the first starting symbol as the number of target reference symbols.

Optionally, the receiving terminal configures the difference between the ending symbol and the second starting symbol as the number of target reference symbols.

Optionally, the receiving terminal configures the value obtained by adding 1 to the difference between the ending symbol and the second starting symbol as the number of target reference symbols.

Optionally, the second starting symbol and/or ending symbol, and the number of slot symbols are indicated by the network device and carried in an RRC message.

Optionally, the second starting symbol and/or ending symbol, and the number of slot symbols are indicated by the transmitting terminal and carried in a sidelink RRC message and/or SCI.

Optionally, the second starting symbol value may be selected from {3, 4, 5, 6, 7}.

Optionally, the ending symbol value may be selected from {6, 7, 8, 9, 10, 11, 12, 13}.

Optionally, the number of slot symbols may be selected from {7, 8, 9, 10, 11, 12, 13, 14}.

Optionally, when the receiving terminal attempts to receive the PSSCH outside the COT, the receiving terminal determines the transport block size based on parameters such as the number of target reference symbols, the PSFCH overhead indicator, the SL-CSI-RS overhead, and the SL-PT-RS overhead.

Optionally, when a receiving terminal attempts to receive the PSSCH within the COT, the receiving terminal determines the transport block size based on parameters such as the number of sidelink slot symbols, the PSFCH overhead indicator, the SL-CSI-RS overhead, and the SL-PT-RS overhead configured by the network device.

Optionally, the receiving terminal determines the number of available resource elements, based on the number of second reference symbols indicated by the SCI, thereby determining the transport block size.

Optionally, the receiving terminal determines the number of available resource elements, based on the number of second reference symbols indicated by the transmitting terminal, thereby determining the transport block size. The indication is carried in a sidelink RRC message.

Optionally, the receiving terminal determines the number of available resource elements, based on the number of second reference symbols indicated by the network device, thereby determining the transport block size. The indication is carried in an RRC message.

Optionally, the number of second reference symbols is determined by the IE ‘sl-LengthSymbols’.

Optionally, the number of second reference symbols can be selected from {7, 8, 9, 10, 11, 12, 13, 14}.

Optionally, the receiving terminal determines the number of target reference symbols based on the first starting symbol and ending symbol, and uses the number of target reference symbols as a parameter for calculating the transport block size.

Optionally, the receiving terminal determines the number of target reference symbols based on the first starting symbol and/or ending symbol and the number of slot symbols, and uses the number of target reference symbols as a parameter for calculating the transport block size.

Optionally, the receiving terminal configures the difference between the number of slot symbols and the second starting symbol as the number of target reference symbols.

Optionally, the receiving terminal configures the difference between the number of slot symbols and the first starting symbol as the number of target reference symbols.

Optionally, the receiving terminal configures the difference between the ending symbol and the first starting symbol as the number of target reference symbols.

Optionally, the receiving terminal configures the value obtained by adding 1 to the difference between the ending symbol and the second starting symbol as the number of target reference symbols.

Optionally, the first starting symbol and/or ending symbol, and the number of slot symbols are indicated by the network device, and this indication is carried in an RRC message.

Optionally, the first starting symbol and/or ending symbol, and the number of slot symbols are indicated by the transmitting terminal, and this indication is carried in a sidelink RRC message.

Optionally, the value of the first starting symbol can be selected from {0, 1, 2, 3, 4, 5, 6, 7}.

Optionally, the ending symbol value may be selected from {6, 7, 8, 9, 10, 11, 12, 13}.

Optionally, the number of slot symbols may be selected from {7, 8, 9, 10, 11, 12, 13, 14}.

Optionally, the first starting symbol is predefined in the specification and may be selected from {0, 1, 2, 3, 4, 5, 6, 7}.

Optionally, the ending symbol is predefined in the specification and may be selected from {6, 7, 8, 9, 10, 11, 12, 13}.

Optionally, the number of slot symbols is predefined in the specification and may be selected from {7, 8, 9, 10, 11, 12, 13, 14}.

Optionally, the receiving terminal first determines the number of REs available for PSSCH transmission within one resource block in a sidelink slot.

Optionally, the receiving terminal determines the number of REs that can be used to transmit PSSCH within one resource block in a sidelink slot based on parameters such as the number of subcarriers, the number of reference symbols, the number of PSFCH symbols, SL-CSI-RS overhead, SL-PT-RS overhead, and SL DMRS overhead in a resource block.

Optionally, the relationship among the parameters is as shown in formula (1):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 1 )$$

Optionally,

$${N}_{sc}^{RB} = 12$$

represents the number of subcarriers in a resource block.

Optionally,

$${N}_{oh}^{PRB}$$

represents the SL-CSI-RS overhead and SL-PT-RS overhead; this parameter is provided by the RRC parameter IE ‘sl-X-Overhead’.

Optionally,

$${N}_{RE}^{DMRS}$$

represents the SL DMRS overhead; this parameter is determined by the RRC parameter IE ‘l-PSSCH-DMRS-TimePatternList’ and Table 1 above.

Optionally, when the higher-layer parameter IE ‘sl-PSFCH-Period’ configures the PSFCH period to 2 or 4, if SCI format 1-A indicates the presence of PSFCH overhead,

$${N}_{s y m b}^{P S F C H} = 3 ;$$

and/or, if SCI format 1-A indicates the absence of PSFCH overhead,

$${N}_{symb}^{PSFCH} = 0 .$$

Optionally, when the higher-layer parameter IE ‘sl-PSFCH-Period’ configures the PSFCH period to 1,

$${N}_{symb}^{PSFCH} = 3 ;$$

and/or, when the higher-layer parameter IE ‘sl-PSFCH-Period’ configures the PSFCH period to 0,

$${N}_{symb}^{PSFCH} = 0 .$$

Optionally, when the PSCCH and PSSCH that the receiving terminal attempts to receive are outside the COT,

$${N}_{s y m b}^{s h}$$

is the number of first reference symbols, and its value can be selected from {7, 8, 9, 10, 11, 12, 13, 14}.

Optionally, the number of first reference symbols is carried in an RRC message and configured by the network device.

Optionally, the number of first reference symbols is carried in a sidelink RRC message and configured by the transmitting terminal.

Optionally, the number of first reference symbols is predefined in the specification.

Optionally,

$${N}_{s y m b}^{s h}$$

is the number of first reference symbols, whose value is indicated by sidelink control information and can be selected from {7, 8, 9, 10, 11, 12, 13, 14}.

Optionally, when the PSCCH and PSSCH that the receiving terminal attempts to receive are outside the COT,

$${N}_{s y m b}^{s h}$$

is determined by the second starting symbol and ending symbol.

Optionally, when the PSCCH and PSSCH that the receiving terminal attempts to receive are within the COT,

$${N}_{s y m b}^{s h}$$

is determined by the first starting symbol and/or ending symbol and the number of symbols in the slot.

Optionally, the receiving terminal configures the difference between the number of slot symbols and the second starting symbol as the number of target reference symbols.

Optionally, the difference between the ending symbol and the second starting symbol is used as the number of target reference symbols.

Optionally, the value obtained by adding 1 to the difference between the ending symbol and the second starting symbol is used as the number of target reference symbols.

Optionally, the value of the second starting symbol can be selected from {3, 4, 5, 6, 7}.

Optionally, the second starting symbol is carried in an RRC message and configured by the network device.

Optionally, the second starting symbol is predefined in the specification.

Optionally, the value of the ending symbol can be selected from {6, 7, 8, 9, 10, 11, 12, 13}.

Optionally, the ending symbol is carried in an RRC message and configured by the network device.

Optionally, the ending symbol is carried in a sidelink RRC message and configured by the transmitting terminal.

Optionally, the value of the number of slot symbols can be selected from {7, 8, 9, 10, 11, 12, 13, 14}.

Optionally, the number of slot symbols is carried in an RRC message and configured by the network device.

Optionally, the number of slot symbols is carried in a sidelink RRC message and configured by the transmitting terminal.

Optionally,

$${N}_{s y m b}^{s h}$$

is determined by the second starting symbol and/or the ending symbol.

Optionally, the receiving terminal configures the difference between the number of slot symbols and the second starting symbol as the number of target reference symbols.

Optionally, the difference between the ending symbol and the second starting symbol is used as the number of reference symbols.

Optionally, the value obtained by adding 1 to the difference between the ending symbol and the second starting symbol is used as the number of reference symbols.

Optionally, the value of the second starting symbol is indicated by sidelink control information, for example, it can be selected from {3, 4, 5, 6, 7}.

Optionally, the value of the ending symbol is indicated by sidelink control information, for example, it can be selected from {6, 7, 8, 9, 10, 11, 12, 13}.

Optionally, the value of the number of slot symbols is indicated by sidelink control information, for example, it can be selected from {7, 8, 9, 10, 11, 12, 13, 14}.

Optionally, if the receiving terminal determines the number of reference symbols based on the second starting symbol and ending symbol, the receiving terminal sets the number of symbols occupied by the PSFCH to zero, that is,

$${N}_{s y m b}^{P S F C H} = 0 .$$

Optionally, if the receiving terminal receives the physical sidelink control channel and/or physical sidelink data channel corresponding to the transmission at the second starting symbol, the receiving terminal sets the number of symbols occupied by the PSFCH to zero, that is

$${N}_{s y m b}^{P S F C H} = 0 .$$

Optionally, when the PSCCH and PSSCH that the receiving terminal attempts to receive are within the COT,

$${N}_{s y m b}^{s h}$$

is the number of second reference symbols, whose value is provided by a higher-layer parameter, for example, it can be selected from {7, 8, 9, 10, 11, 12, 13, 14}.

Optionally, the high-level parameter is an RRC message and is configured by the network.

Optionally, the high-level parameter is a sidelink RRC message and is configured by the transmitting terminal.

Optionally,

$${N}_{s y m b}^{s h}$$

is the number of second reference symbols, whose value is indicated by the sidelink control information and can be selected from {7, 8, 9, 10, 11, 12, 13, 14}.

Optionally, when the PSCCH and PSSCH that the receiving terminal attempts to receive are within the COT,

$${N}_{s y m b}^{s h}$$

is determined by the first starting symbol and ending symbol.

Optionally, when the PSCCH and PSSCH that the receiving terminal attempts to receive are within the COT,

$${N}_{s y m b}^{s h}$$

is determined by the first starting symbol and/or ending symbol and the number of slot symbols.

Optionally, the receiving terminal configures the difference between the number of slot symbols and the second starting symbol as the number of target reference symbols.

Optionally, the difference between the ending symbol and the first starting symbol is used as the number of reference symbols.

Optionally, the value obtained by adding 1 to the difference between the ending symbol and the first starting symbol is used as the number of reference symbols.

Optionally, the value of the first starting symbol is provided by a higher-layer parameter, for example, it can be selected from {0, 1, 2, 3, 4, 5, 6, 7}.

Optionally, the value of the ending symbol is provided by a higher-layer parameter, for example, it can be selected from {6, 7, 8, 9, 10, 11, 12, 13}.

Optionally, the higher-layer parameter is an RRC message configured by the network.

Optionally, the higher-layer parameter is a sidelink RRC message configured by the transmitting terminal.

Optionally,

$${N}_{s y m b}^{s h}$$

is determined by the first starting symbol and the ending symbol.

Optionally, the difference between the ending symbol and the first starting symbol is used as the number of reference symbols.

Optionally, the value obtained by adding 1 to the difference between the ending symbol and the second starting symbol is used as the number of reference symbols.

Optionally, the value of the first starting symbol is indicated by the sidelink control information, for example, it can be selected from {0, 1, 2, 3, 4, 5, 6, 7}. The value of the ending symbol is also indicated by the sidelink control information, for example, it can be selected from {6, 7, 8, 9, 10, 11, 12, 13}.

Optionally,

$${N}_{s y m b}^{s h}$$

is the number of available symbols for PSSCH transmission in the sidelink slot, provided by a higher-layer parameter, for example, from the IE ‘sl-LengthSymbols’.

Optionally, the higher-layer parameter is an RRC message configured by the network.

Optionally, the higher-layer parameter is a sidelink RRC message configured by the transmitting terminal.

Optionally, the receiving terminal determines N_{RE}, the total number of resource elements available for PSSCH transmission in a sidelink slot.

Optionally, the receiving terminal determines the total number of resource elements available for PSSCH transmission based on the resource block number available for PSSCH transmission, the number of resource elements occupied by the PSCCH and PSCCH DMRS, and the number of coded modulation symbols used for two-stage SCI transmission.

Optionally, the relationship among the parameters is as shown in the following formula (2):

$${N}_{R E} = {N}_{R E}^{′} \cdot {n}_{P R B} - {N}_{R E}^{SCI , 1} - {N}_{R E}^{SCI , 2} \qquad ( 2 )$$

N_{RE} is the total number of resource elements available for PSSCH transmission in a sidelink slot.

$${N}_{RE}^{′}$$

is the total number of resource elements available for PSSCH transmission within one resource block in a sidelink slot.

n_{PRB} is the total number of resource blocks available for PSSCH transmission.

$${N}_{RE}^{SCI , 1}$$

is the number of resource elements occupied by PSCCH and PSCCH DMRS.

$${N}_{RE}^{SCI , 2}$$

is the number of coded modulation symbols used for two-stage SCI transmission.

The number of non-quantized temporary information bits N_{info} is obtained by the following formula (3):

$${N}_{info} = {N}_{RE} \cdot R \cdot {Q}_{m} \cdot υ \qquad ( 3 )$$

N_{RE} is the total number of resource elements available for PSSCH transmission in a sidelink slot.

R is the target code rate.

Qₘ is the modulation order.

v is the number of layers.

Optionally, when N_{info}≤3824, N_{info} is first quantized to obtain N_{info′}, that is

$${N}_{info}^{′} = max ( 24 , {2}^{n} \cdot ⌊ \frac{{N}_{info}}{{2}^{n}} ⌋ ) .$$

n=max(3, └log₂(N_{info})┘−6). Then, from Table 2 above, find the value closest to and less than or equal to N_{info′} as the transport block size.

Optionally, when N_{info}>3824, the transport block size is calculated using the following formula (4):

Optionally, N_{info} is first quantized to obtain N_{info′}, i.e.

$${N}_{info}^{′} = max ( 3840 , {2}^{n} \times round ( \frac{{N}_{info} - 24}{{2}^{n}} ) ) \qquad ( 4 )$$

where n=└log₂(N_{info}−24)┘−5

Then, the following formula is used to calculate the transport block size.

Optionally, if R≤¼, then

$$T B S = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{3816} ⌉ .$$

Optionally, if R>¼ and N_{info′}>8424, then

$$T B S = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{8424} ⌉ .$$

Optionally, if R>¼ and N_{info′}≤8424, then

$$T B S = 8 \cdot ⌈ \frac{{N}_{info}^{′} + 24}{8} ⌉ - 24.$$

In technical solution of this embodiment, the receiving terminal determines the number of target reference symbols according to the first strategy, and the number of target reference symbols is configured to determine the transport block size. Therefore, the receiving terminal can select different number of reference symbols according to the first strategy to determine the transport block size, thereby ensuring transmission efficiency.

### Fourth Embodiment

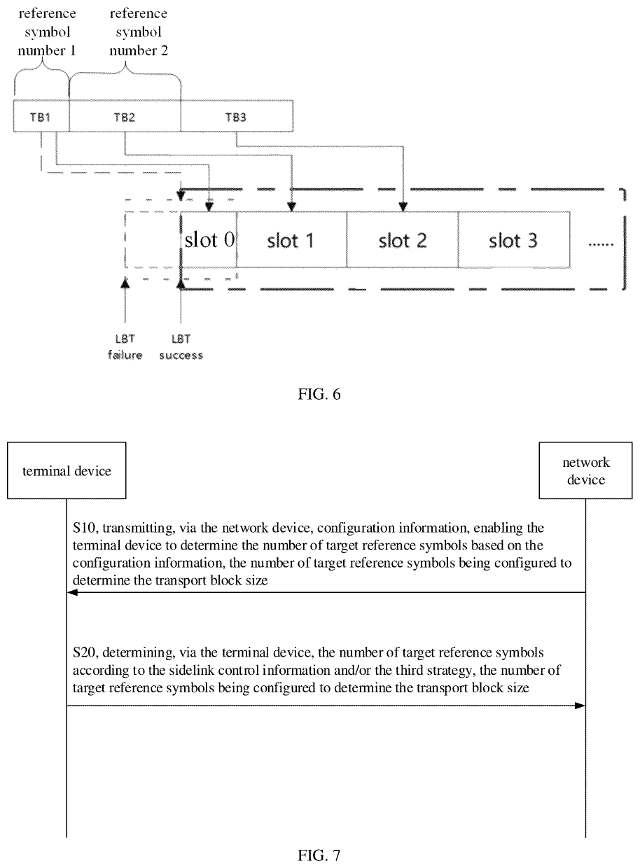

As shown in FIG. 7, the fourth embodiment of the present application provides a processing method, including the following steps:
S30: transmitting, via a network device, configuration information, enabling a terminal device to determine a number of target reference symbols based on the configuration information, the number of target reference symbols being configured to determine a transport block size; and
S40: determining, via the terminal device, the number of target reference symbols based on sidelink control information and/or a third strategy, the number of target reference symbols being configured to determine the transport block size.

Optionally, for physical sidelink control channel transmission and/or physical sidelink data channel transmission, two starting symbols are configured for a slot within a resource pool.

Optionally, the transmitting terminal and/or the receiving terminal determines at least one number of target reference symbols based on the resource pool configuration information, wherein at least one number of target reference symbols is configured to determine the number of available resource elements, thereby determining the transport block size.

Optionally, the network device configures at least one number of target reference symbols for the resource pool, and the configuration information is included in the resource pool configuration information.

Optionally, the resource pool configuration information is predefined.

Optionally, the number of target reference symbols may be selected from {7, 8, 9, 10, 11, 12, 13, 14}.

Optionally, if the transmitting terminal transmits the physical sidelink control channel and/or physical sidelink data channel corresponding to the transmission at the second starting symbol, the transmitting terminal sets the number of symbols occupied by the PSFCH to zero, i.e.,

$${N}_{symb}^{PSFCH} = 0 .$$

Optionally, determining the number of target reference symbols based on the sidelink control information includes at least one of the following:

Optionally, the transmitting terminal and/or the receiving terminal determines at least one number of target reference symbols based on the starting symbol, and the at least one number of target reference symbols is configured to determine the number of available resource elements, thereby determining the transport block size.

Optionally, determining at least one number of target reference symbols based on the starting symbols satisfies the formula:

$$L\_ref = ( L - S ) ;$$

Optionally, L_ref is the number of target reference symbols;
Optionally, L is the number of slot symbols, whose value is provided by a higher-layer parameter, for example, selected from {7, 8, 9, 10, 11, 12, 13, 14}.

Optionally, S is the first starting symbol, whose value is provided by a higher-layer parameter, for example, selected from {0, 1, 2, 3, 4, 5, 6, 7}.

Optionally, the determining at least one number of target reference symbols based on the first starting symbol includes at least one of the following:
if the first starting symbol is symbol 0, the number of target reference symbols is 14;
if the first starting symbol is symbol 1, the number of target reference symbols is 13;
if the first starting symbol is symbol 2, the number of target reference symbols is 12;
if the first starting symbol is symbol 3, the number of target reference symbols is 11;
if the first starting symbol is symbol 4, the number of target reference symbols is 10;
if the first starting symbol is symbol 5, the number of target reference symbols is 9;
if the first starting symbol is symbol 6, the number of target reference symbols is 8;
if the first starting symbol is symbol 7, the number of target reference symbols is 7.

Optionally, the transmitting terminal indicates, in the sidelink control information, whether the number of target reference symbols for the current transmission is determined based on the configuration information or based on the first starting symbol.

Optionally, if the transmitting terminal indicates 0 in the indication information of the sidelink control information, it means that the target reference symbols for the current transmission are determined based on the configuration information.

Optionally, if the transmitting terminal indicates 1 in the indication information of the sidelink control information, it means that the target reference symbols for the current transmission are determined based on the starting symbol.

Optionally, the receiving terminal receives the sidelink control information, if the indication information indicates 0, it means that the target reference symbols for the current transmission are determined based on the configuration information.

Optionally, the receiving terminal receives the sidelink control information, if the indication information indicates 1, it means that the target reference symbols for the current transmission are determined based on the starting symbol.

Optionally, S is a second starting symbol, whose value is provided by a higher-layer parameter, for example, it can be selected from {3, 4, 5, 6, 7}.

Optionally, the determining at least one number of target reference symbols based on the second starting symbol includes at least one of the following:
if the second starting symbol is symbol 3, the number of target reference symbols is 11;
if the second starting symbol is symbol 4, the number of target reference symbols is 10;
if the second starting symbol is symbol 5, the number of target reference symbols is 9;
if the second starting symbol is symbol 6, the number of target reference symbols is 8;
if the second starting symbol is symbol 7, the number of target reference symbols is 7.

Optionally, the transmitting terminal indicates, in the sidelink control information, whether the number of target reference symbols for the current transmission is determined based on the configuration information or based on the second starting symbol.

Optionally, if the transmitting terminal indicates 1 in the indication information of the sidelink control information, it means that the target reference symbols for the current transmission are determined based on the configuration information.

Optionally, if the transmitting terminal indicates 0 in the indication information of the sidelink control information, it means that the target reference symbols for the current transmission are determined based on the starting symbol.

Optionally, the receiving terminal receives the sidelink control information, and if the indication information indicates 1, it means that the target reference symbols for the current transmission are determined based on the configuration information.

Optionally, the receiving terminal receives the sidelink control information, and if the indication information indicates 0, it means that the target reference symbols for the current transmission are determined based on the starting symbol.

Optionally, if the transmitting terminal transmits the physical sidelink control channel and/or physical sidelink data channel corresponding to the transmission at the second starting symbol, the transmitting terminal sets the number of symbols occupied by the PSFCH to zero, that is,

$${N}_{symb}^{PSFCH} = 0 .$$

Optionally, if the receiving terminal receives the physical sidelink control channel and/or physical sidelink data channel corresponding to the transmission at the second starting symbol, the receiving terminal sets the number of symbols occupied by the PSFCH to zero, that is,

$${N}_{symb}^{PSFCH} = 0 .$$

Optionally, whether to use the first starting symbol or the second starting symbol is configured by a higher-layer parameter.

Optionally, whether to use the first starting symbol or the second starting symbol is predefined.

Optionally, whether to use the first starting symbol or the second starting symbol is configured for each resource pool, i.e., each resource pool shares the same starting symbol.

Optionally, the third strategy is related to the configuration information.

Optionally, determining the number of target reference symbols according to the third strategy includes at least one of the following:
when the transmission occurs outside the COT, the terminal device selecting the number of target reference symbols configured or predefined by the network;
when the transmission occurs within the COT, the terminal device determining the number of target reference symbols based on a first starting symbol;
when the transmission occurs within the COT, the terminal device determining the number of target reference symbols based on a second starting symbol.

Optionally, at least one of the number of target reference symbols, the first starting symbol, and the second starting symbol is configured by the network device.

Optionally, the first starting symbol configured by the network device for the transmitting terminal is provided by higher-layer signaling and can be selected from {0, 1, 2, 3, 4, 5, 6, 7}.

Optionally, the higher-layer signaling is carried in an RRC message.

Optionally, the higher-layer signaling is carried in a MAC CE.

Optionally, the first starting symbol is predefined in the specification and can be selected from {0, 1, 2, 3, 4, 5, 6, 7}.

Optionally, if the first starting symbol is not configured, the first starting symbol defaults to symbol 0.

Optionally, the second starting symbol configured by the network device for the transmitting terminal is provided by higher-layer signaling and can be selected from {3, 4, 5, 6, 7}.

Optionally, the higher-layer signaling is carried in an RRC message.

Optionally, the higher-layer signaling is carried in a MAC CE.

Optionally, the second starting symbol is predefined in the specification and can be selected from {3, 4, 5, 6, 7}.

Optionally, the transmitting terminal indicates the number of target reference symbols to the receiving terminal via the SCI, and the number of target reference symbols serves as a parameter for calculating the transport block size.

Optionally, the number of target reference symbols can be selected from {7, 8, 9, 10, 11, 12, 13, 14}.

Optionally, if the transmitting terminal transmits the physical sidelink control channel and/or physical sidelink data channel corresponding to the transmission on the second starting symbol, the transmitting terminal sets the number of symbols occupied by the PSFCH to zero, i.e.,

$${N}_{symb}^{PSFCH} = 0 .$$

Optionally, before transmission, the transmitting terminal performs a channel access procedure, such as performing a Type 1 channel access procedure, namely, performing LBT.

Optionally, if the terminal successfully performs LBT and it is the first transmission, the transmitting terminal may be considered to have occupied the channel, i.e., the transmitting terminal has initiated the COT.

Optionally, the transmission occurring outside the COT means that the transmitting terminal has not yet occupied the channel, or in other words, has not yet initiated the COT, when preparing to perform the transmission.

Optionally, the transmission occurring outside the COT means that the transmitting terminal performs LBT for the transmission and upon successful LBT, initiates the COT.

Optionally, such a transmission that initiates the COT is considered to be the transmission occurring outside the COT.

Optionally, the transmission occurring within the COT means that the transmission occurs in a slot within the COT. For example, the transmission occurs in a slot of the COT other than the first slot.

Optionally, the transmission occurring within the COT means that the transmitting terminal obtains the COT after a successful LBT, and then transmits in some slots included in the COT, wherein these slots are slots of the COT other than the first slot.

Optionally, the transmitting terminal indicates COT information via sidelink control information. The COT information includes at least one of the following:
remaining COT duration,
COT length in units of slots,
uplink/downlink pattern in the time domain, and
resource block set index.

Optionally, the COT start time is the slot in which the sidelink control information carrying the COT information is located.

Optionally, the COT location in the time domain is determined using the COT start time and the COT information. By determining the COT location in the time domain and the location of the transmission in the time domain, it is possible to determine whether the transmission occurs within or outside the COT.

Optionally, determining the number of target reference symbols according to the third strategy further includes at least one of the following:
if the receiving terminal does not receive COT information, the receiving terminal determining the number of target reference symbols according to configuration information;
if the receiving terminal receives COT information and the transmission occurs outside the COT, the receiving terminal determining the number of target reference symbols according to the configuration information;
if the receiving terminal receives COT information and the transmission occurs within the COT, the receiving terminal determining the number of target reference symbols according to a starting symbol.

Optionally, the configuration information is included in the resource pool configuration information.

Optionally, the resource pool configuration information is predefined.

Optionally, the number of target reference symbols may be selected from {7, 8, 9, 10, 11, 12, 13, 14}.

Optionally, if the receiving terminal does not receive COT information, the receiving terminal determines the number of target reference symbols based on a preset value. For example, the preset value is one of {7, 8, 9, 10, 11, 12, 13, 14}.

Optionally, if the receiving terminal does not receive COT information and the receiving terminal receives the physical sidelink control channel and/or physical sidelink data channel corresponding to the transmission starting from the first starting symbol, the receiving terminal determines the number of target reference symbols according to a preset value, for example, a value selected from {7, 8, 9, 10, 11, 12, 13, 14}.

Optionally, if the receiving terminal does not receive the COT information and the receiving terminal begins to receive the physical sidelink control channel and/or the physical sidelink data channel corresponding to the transmission at the second starting symbol, the receiving terminal determines the number of target reference symbols according to a preset value, for example, a value selected from {7, 8, 9, 10, 11, 12, 13, 14}.

Optionally, if the receiving terminal does not receive COT information and begins receiving the physical sidelink control channel and/or physical sidelink data channel corresponding to the transmission starting at the second starting symbol, the receiving terminal sets the number of symbols occupied by the PSFCH to zero, i.e.,

$${N}_{symb}^{PSFCH} = 0 .$$

Optionally, if the receiving terminal does not receive COT information, but receives the physical sidelink control channel and/or physical sidelink data channel transmitted by the transmitting terminal in the previous slot, and then receives the physical sidelink control channel and/or physical sidelink data channel in the current slot, the receiving terminal determines the number of target reference symbols based on the first starting symbol. For example, the number of target reference symbols can be one of {7, 8, 9, 10, 11, 12, 13, 14}.

Optionally, if the receiving terminal does not receive COT information, but the receiving terminal received a physical sidelink control channel and/or a physical sidelink data channel transmitted by the transmitting terminal in a previous slot, and the receiving terminal receives the physical sidelink control channel and/or the physical sidelink data channel starting from the first starting symbol in the current slot, the receiving terminal determines the number of target reference symbols based on the first starting symbol, for example, a value selected from {7, 8, 9, 10, 11, 12, 13, 14}.

Optionally, if the receiving terminal does not receive COT information, but the receiving terminal received a physical sidelink control channel and/or a physical sidelink data channel sent by the transmitting terminal in a previous slot, and the receiving terminal receives the physical sidelink control channel and/or the physical sidelink data channel in the current slot, the receiving terminal determines the number of target reference symbols based on the second starting symbol, for example, a value selected from {7, 8, 9, 10, 11, 12, 13, 14}.

Optionally, if the receiving terminal does not receive COT information, but the receiving terminal received a physical sidelink control channel and/or a physical sidelink data channel sent by the transmitting terminal in the previous slot, and the receiving terminal begins receiving the physical sidelink control channel and/or the physical sidelink data channel at the second starting symbol in the current slot, the receiving terminal determines the number of target reference symbols based on the second starting symbol, for example, a value selected from {7, 8, 9, 10, 11, 12, 13, 14}.

Optionally, the receiving terminal first determines the number of REs available for PSSCH transmission within one resource block in a sidelink slot.

Optionally, the receiving terminal determines the number of REs available for PSSCH transmission within one resource block in a sidelink slot based on parameters such as the number of subcarriers, the number of reference symbols, the number of PSFCH symbols, SL-CSI-RS overhead, SL-PT-RS overhead, and SL DMRS overhead in a resource block.

Optionally, the relationship among the parameters is shown in formula (1):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 1 )$$

Optionally,

$${N}_{sc}^{RB} = 12$$

represents the number of subcarriers in a resource block.

Optionally,

$${N}_{oh}^{PRB}$$

represents the SL-CSI-RS overhead and SL-PT-RS overhead; this parameter is provided by the RRC parameter IE ‘sl-X-Overhead’.

Optionally,

$${N}_{RE}^{DMRS}$$

represents the SL DMRS overhead; this parameter is determined by the RRC parameter IE ‘l-PSSCH-DMRS-TimePatternList’ and Table 1 above.

Optionally, when the higher-layer parameter IE ‘sl-PSFCH-Period’ configures the PSFCH period to 2 or 4, if SCI format 1-A indicates the presence of PSFCH overhead,

$${N}_{symb}^{PSFCH} = 3 ;$$

and/or, if SCI format 1-A indicates the absence of PSFCH overhead,

$${N}_{symb}^{PSFCH} = 0 .$$

Optionally, when the higher-layer parameter IE ‘sl-PSFCH-Period’ configures the PSFCH period to 1,

$${N}_{symb}^{PSFCH} = 3 ;$$

and/or, when the higher-layer parameter IE ‘sl-PSFCH-Period’ configures the PSFCH period to 0,

$${N}_{symb}^{PSFCH} = 0 .$$

Optionally, when the receiving terminal receives COT information and the PSCCH and PSSCH it attempts to receive are outside the COT,

$${N}_{symb}^{sh}$$

is the number of target reference symbols, which can be selected from {7, 8, 9, 10, 11, 12, 13, 14}.

Optionally, the number of target reference symbols is carried in an RRC message and configured by the network device.

Optionally, the number of target reference symbols is carried in a sidelink RRC message and configured by the transmitting terminal.

Optionally, the number of target reference symbols is predefined in the specification.

Optionally,

$${N}_{symb}^{sh}$$

is the number of target reference symbols, whose value is indicated by the sidelink control information and can be selected from {7, 8, 9, 10, 11, 12, 13, 14}.

Optionally, when the receiving terminal receives COT information and the PSCCH and PSSCH it attempts to receive are outside the COT,

$${N}_{symb}^{sh}$$

is determined by the second starting symbol and the number of slot symbols.

Optionally, when the receiving terminal receives COT information and the PSCCH and PSSCH it attempts to receive are within the COT,

$${N}_{symb}^{sh}$$

is determined by the first starting symbol and the number of slot symbols.

Optionally, the receiving terminal configures the difference between the number of slot symbols and the second starting symbol as the number of target reference symbols.

Optionally, the second starting symbol may be selected from {3, 4, 5, 6, 7}.

Optionally, the second starting symbol is carried in an RRC message and configured by the network device.

Optionally, the second starting symbol is predefined in the specification.

Optionally, the number of slot symbols may be selected from {7, 8, 9, 10, 11, 12, 13, 14}.

Optionally, the number of slot symbols is carried in an RRC message and configured by the network device.

Optionally, the number of slot symbols is carried in a sidelink RRC message and configured by the transmitting terminal.

Optionally,

$${N}_{symb}^{sh}$$

is determined by the second starting symbol and the number of slot symbols.

Optionally, the receiving terminal configures the difference between the number of slot symbols and the second starting symbol as the number of target reference symbols.

Optionally, the value of the second starting symbol is indicated by sidelink control information, for example, it can be selected from {3, 4, 5, 6, 7}.

Optionally, the value of the number of slot symbols is indicated by sidelink control information, for example, it can be selected from {7, 8, 9, 10, 11, 12, 13, 14}.

Optionally, if the receiving terminal determines the number of reference symbols based on the second starting symbol and the number of slot symbols, the receiving terminal sets the number of symbols occupied by the PSFCH to zero, that is,

$${N}_{symb}^{PSFCH} = 0 .$$

Optionally, if the receiving terminal receives the physical sidelink control channel and/or physical sidelink data channel corresponding to the transmission at the second starting symbol, the receiving terminal sets the number of symbols occupied by the PSFCH to zero, i.e.,

$${N}_{symb}^{PSFCH} = 0 .$$

Optionally, when the PSCCH and PSSCH that the receiving terminal attempts to receive are within the COT,

$${N}_{sym b}^{sh}$$

is the number of second reference symbols, whose value is provided by a higher-layer parameter, for example, selected from {7, 8, 9, 10, 11, 12, 13, 14}.

Optionally, the higher-layer parameter is an RRC message configured by the network.

Optionally, the higher-layer parameter is a sidelink RRC message configured by the transmitting terminal.

Optionally,

$${N}_{symb}^{sh}$$

is the number of second reference symbols, whose value is indicated by sidelink control information and can be selected from {7, 8, 9, 10, 11, 12, 13, 14}.

Optionally, when the PSCCH and PSSCH that the receiving terminal attempts to receive are within the COT,

$${N}_{sym b}^{sh}$$

is determined by the first starting symbol.

Optionally, when the PSCCH and PSSCH that the receiving terminal attempts to receive are within the COT,

$${N}_{sym b}^{sh}$$

is determined by the first starting symbol and the number of slot symbols.

Optionally, the receiving terminal configures the difference between the number of slot symbols and the first starting symbol as the number of target reference symbols.

Optionally, the value of the first starting symbol is provided by a higher-layer parameter, for example, it can be selected from {0, 1, 2, 3, 4, 5, 6, 7}.

Optionally, the value of the number of slot symbols is provided by a higher-layer parameter, for example, it can be selected from {7, 8, 9, 10, 11, 12, 13, 14}.

Optionally, the higher-layer parameter is an RRC message configured by the network.

Optionally, the higher-layer parameter is a sidelink RRC message configured by the transmitting terminal.

Optionally, the value of the first starting symbol is indicated by the sidelink control information, for example, it can be selected from {0, 1, 2, 3, 4, 5, 6, 7}. The value of the number of slot symbols is also indicated by the sidelink control information, for example, it can be selected from {7, 8, 9, 10, 11, 12, 13, 14}.

Optionally,

$${N}_{sym b}^{sh}$$

is the number of available symbols for PSSCH transmission in the sidelink slot, provided by a higher-layer parameter, for example, from the IE ‘sl-LengthSymbols’.

Optionally, the higher-layer parameter is an RRC message configured by the network.

Optionally, the higher-layer parameter is a sidelink RRC message configured by the transmitting terminal.

Optionally, if the receiving terminal does not receive COT information and receives the physical sidelink control channel and/or physical sidelink data channel corresponding to the transmission starting from the first starting symbol,

$${N}_{sym b}^{sh}$$

is the number of target reference symbols, whose value is one of {7, 8, 9, 10, 11, 12, 13, 14}.

Optionally, if the receiving terminal does not receive COT information and receives the physical sidelink control channel and/or physical sidelink data channel corresponding to the transmission starting from the second starting symbol,

$${N}_{sym b}^{sh}$$

is the number of target reference symbols, whose value is one of {7, 8, 9, 10, 11, 12, 13, 14}.

Optionally, if the receiving terminal does not receive COT information and receives the physical sidelink control channel and/or physical sidelink data channel corresponding to the transmission starting from the second starting symbol, the receiving terminal sets the number of symbols occupied by the PSFCH to zero, i.e.,

$${N}_{symb}^{PSFCH} = 0 .$$

Optionally, if the receiving terminal does not receive COT information, but receives the physical sidelink control channel and/or physical sidelink data channel transmitted by the transmitting terminal in the previous slot, and then receives the physical sidelink control channel and/or physical sidelink data channel in the current slot, the receiving terminal determines the number of target reference symbols

$${N}_{sym b}^{sh}$$

based on the first starting symbol. For example,

$${N}_{sym b}^{sh}$$

can be a value among {7, 8, 9, 10, 11, 12, 13, 14}.

Optionally, if the receiving terminal does not receive COT information, but receives the physical sidelink control channel and/or the physical sidelink data channel transmitted by the transmitting terminal in the previous slot, and the receiving terminal receives the physical sidelink control channel and/or the physical sidelink data channel starting from the first starting symbol in the current slot, the receiving terminal determines the number of target reference symbols

$${N}_{sym b}^{sh}$$

based on the first starting symbol. For example,

$${N}_{sym b}^{sh}$$

can be a value among {1, 0, 9, 10, 11, 12, 13, 14}.

Optionally, if the receiving terminal does not receive COT information, but the receiving terminal received a physical side link control channel and/or a physical side link data channel sent by the transmitting terminal in a previous slot, and the receiving terminal receives the physical side link control channel and/or the physical side link data channel in a current slot, the receiving terminal determines the number of target reference symbols

$${N}_{sym b}^{sh}$$

based on the second starting symbol. For example,

$${N}_{s y m b}^{s h}$$

can be a value among {7, 8, 9, 10, 11, 12, 13, 14}.

Optionally, if the receiving terminal does not receive COT information, but the receiving terminal received a physical side link control channel and/or a physical side link data channel sent by the transmitting terminal in a previous slot, and the receiving terminal receives the physical side link control channel and/or the physical side link data channel starting from the second starting symbol in the current slot, the receiving terminal determines the number of target reference symbols

$${N}_{s y m b}^{s h}$$

based on the second starting symbol. For example,

$${N}_{s y m b}^{s h}$$

can be a value among {7, 8, 9, 10, 11, 12, 13, 14}.

Optionally, the receiving terminal determines the total number of all resource elements available for PSSCH transmission in a sidelink slot.

Optionally, the receiving terminal determines the total number of resource elements available for PSSCH transmission based on the resource block number available for PSSCH transmission, the number of resource elements occupied by PSCCH and PSCCH DMRS, and the number of coded modulation symbols used for two-stage SCI transmission.

Optionally, the relationship between the parameters is shown in the following formula (2):

$${N}_{R E} = {N}_{R E}^{′} \cdot {n}_{P R B} - {N}_{R E}^{SCI , 1} - {N}_{R E}^{SCI , 2} \qquad ( 2 )$$

N_{RE} is the total number of resource elements available for PSSCH transmission in a sidelink slot.

$${N}_{R E}^{′}$$

is the total number of resource elements available for PSSCH transmission within one resource block in a sidelink slot.

n_{PRB} is the total number of resource blocks available for PSSCH transmission.

$${N}_{R E}^{SCI , 1}$$

is the number of resource elements occupied by PSCCH and PSCCH DMRS.

$${N}_{R E}^{SCI , 2}$$

is the number of coded modulation symbols used for two-stage SCI transmission.

The number of non-quantized temporary information bits N_{info} is obtained by the following formula (3):

$${N}_{info} = {N}_{R E} \cdot R \cdot {Q}_{m} \cdot υ \qquad ( 3 )$$

N_{RE} is the total number of resource elements available for PSSCH transmission in a sidelink slot.

R is the target code rate.

Qₘ is the modulation order.

v is the number of layers.

Optionally, when N_{info}≤3824, N_{info} is first quantized to obtain N_{info′}, that is

$${N}_{info}^{′} = max ( 24 , {2}^{n} \cdot ⌊ \frac{{N}_{info}}{{2}^{n}} ⌋ ) .$$

n=max(3, └log₂(N_{info})┘−6). Then, from Table 2 above, find the value closest to and less than or equal to N_{info′} as the transport block size.

Optionally, when N_{info}>3824, the transport block size is calculated using the following formula (4):

Optionally, N_{info} is first quantized to obtain N_{info′}, i.e.

$${N}_{info}^{′} = max ( 3840 , {2}^{n} \times round ( \frac{{N}_{info} - 24}{{2}^{n}} ) ) \qquad ( 4 )$$

where n=└log₂(N_{info}−24)┘−5

Then, the following formula is used to calculate the transport block size.

Optionally, if R≤¼, then

$$TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{3816} ⌉ .$$

Optionally, if R>¼ and N_{info′}>8424, then

$$TBS = 8 \cdot C \cdot ⌈ \frac{{N}_{info}^{′} + 24}{8 \cdot C} ⌉ - 24 ,$$

where

$$C = ⌈ \frac{{N}_{info}^{′} + 24}{8424} ⌉ .$$

Optionally, if R>¼ and N_{info′}≤8424, then

$$TBS = 8 \cdot ⌈ \frac{{N}_{info}^{′} + 24}{8} ⌉ - 24 .$$

In technical solution of this embodiment, the receiving terminal determines the number of target reference symbols based on the sidelink control information and/or the third strategy. The number of target reference symbols is configured to determine the transport block size. This allows the receiving terminal to select different number of reference symbols for determining the transport block size based on the sidelink control information and/or the third strategy, thereby ensuring transmission efficiency.

The embodiments of the present application further provides a processing apparatus, applied to or being a terminal device, including:

a determination module configured to determine a number of target reference symbols based on a first strategy, the number of target reference symbols being configured to determine a transport block size.

Optionally, the determining the number of target reference symbols based on the first strategy includes at least one of the following:
when transmission occurs outside a COT, selecting, via the terminal device, a number of first reference symbols as the number of target reference symbols;
when transmission occurs within the COT, selecting, via the terminal device, a number of second reference symbols as the number of target reference symbols;
when transmission occurs outside the COT, determining, via the terminal device, the number of target reference symbols based on a second starting symbol and/or ending symbol; and
when transmission occurs within the COT, determining, via the terminal device, the number of target reference symbols based on a first starting symbol and/or ending symbol.

Optionally, the apparatus further includes at least one of the following:
at least one of the number of first reference symbols, the number of second reference symbols, the first starting symbol, the second starting symbol, the ending symbol, and the number of slot symbols is configured by a network device;
the terminal device is a receiving terminal, and at least one of the number of first reference symbols, the number of second reference symbols, the first starting symbol, the second starting symbol, the ending symbol, and the number of slot symbols is transmitted by a transmitting terminal;
the number of first reference symbols is less than or equal to the number of second reference symbols; and
the first starting symbol is earlier than or identical to the second starting symbol.

Optionally, the determining, via the terminal device, the number of target reference symbols based on the second starting symbol and/or ending symbol includes at least one of the following:
setting a number of symbols occupied by the PSFCH to zero, determining, via the terminal device, the number of target reference symbols based on the second starting symbol and/or ending symbol, the number of slot symbols, and the number of symbols occupied by the PSFCH;
configuring a difference between the number of slot symbols and the second starting symbol as the number of target reference symbols; and
configuring a difference between the ending symbol and the second starting symbol as the number of target reference symbols.

Optionally, the apparatus further includes determining the transport block size based on a second strategy, and/or the determining the transport block size based on the second strategy includes at least one of the following:
determining the transport block size based on the number of target reference symbols;
when a terminal device attempts to transmit the PSSCH outside the COT, determining the transport block size based on a number of first reference symbols, a PSFCH overhead indicator, SL-CSI-RS overhead, and SL-PT-RS overhead configured by a network device;
when the terminal device attempts to transmit the PSSCH within the COT, determining the transport block size based on a number of second reference symbols, the PSFCH overhead indicator, the SL-CSI-RS overhead, and the SL-PT-RS overhead configured by the network device;
when the terminal device attempts to receive the PSSCH outside the COT, determining the transport block size based on the number of first reference symbols indicated by SCI and/or the PSFCH overhead indicator, the SL-CSI-RS overhead, and the SL-PT-RS overhead configured by the network device; and
when the terminal device attempts to receive the PSSCH within the COT, determining the transport block size based on a number of sidelink slot symbols, the PSFCH overhead indicator, the SL-CSI-RS overhead, and the SL-PT-RS overhead configured by the network device.

The embodiments of the present application further provides a processing apparatus, applied to or being a network device, comprising:
a transmitting module configured to transmit configuration information, enabling a terminal device to determine a number of target reference symbols based on the configuration information. The number of target reference symbols is configured to determine a transport block size.

Optionally, the terminal device determining the number of target reference symbols based on the configuration information includes at least one of the following:
when transmission occurs outside a COT, selecting, via the terminal device, a number of first reference symbols as the number of target reference symbols;
when transmission occurs within the COT, selecting, via the terminal device, a number of second reference symbols as the number of target reference symbols;
when transmission occurs outside the COT, determining, via the terminal device, the number of target reference symbols based on a second starting symbol and/or ending symbol; and
when transmission occurs within the COT, determining, via the terminal device, the number of target reference symbols based on a first starting symbol and/or ending symbol.

Optionally, the configuration information is transmitted by a network device or a transmitting device; and/or the configuration information includes at least one of the following: at least two sets of number of reference symbols, a number of first reference symbols, a number of second reference symbols, a first starting symbol, a second starting symbol, an ending symbol, and the number of slot symbols.

An embodiment of the present application also provides a communication system, including a terminal device as described in any of the above method embodiments; and a network device as described in any of the above method embodiments.

An embodiment of the present application also provides a communication device, including a memory and a processor, the memory stores a processing program, and when the processing program is executed by the processor, the steps of the processing method described in any of the above embodiments are implemented.

The communication device in the present application can be a terminal device (such as a mobile phone) or a network device (such as a base station), and the specific reference should be clarified based on the context.

The present application also provides a storage medium storing a processing program. When executed by a processor, the processing program implements the steps of any of the processing methods described in the aforementioned embodiments.

The communication device and the storage medium provided in the present application may include all of the technical features of any of the aforementioned processing method embodiments. The expanded description and explanations are essentially the same as those in the aforementioned method embodiments and are not further elaborated here.

The present application also provides a computer program product including a computer program code. When the computer program code is executed on a computer, the computer executes the methods described in the various possible embodiments.

The present application also provides a chip including a memory and a processor. The memory is configured to store a computer program, and the processor is configured to retrieve and execute the computer program from the memory, thereby causing a device equipped with the chip to execute the methods described in the various possible embodiments.

It can be understood that the above-mentioned scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are for description only and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terminology, technical solution and/or application scenario description is generally described in detail only when it appears for the first time. When it appears again later, it is generally not repeated for the sake of brevity. When understanding the technical solution and other contents of the present application, for the same or similar terminology, technical solution and/or application scenario description that is not described in detail later, please refer to the previous related detailed description.

In the present application, the descriptions of various embodiments have different focuses. For parts that are not described or denoted in a certain embodiment, please refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to fall within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line (DSL)) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
determining a number of target reference symbols, the number of target reference symbols being configured to determine a transport block size.

2. The method according to claim 1, wherein the determining the number of target reference symbols comprises at least one of the following:
when a transmission occurs outside a Channel Occupancy Time (COT), selecting, via the terminal device, a number of first reference symbols as the number of target reference symbols;
when the transmission occurs within the COT, selecting, via the terminal device, a number of second reference symbols as the number of target reference symbols;
when the transmission occurs outside the COT, determining, via the terminal device, the number of target reference symbols based on a second starting symbol and/or ending symbol; and
when the transmission occurs within the COT, determining, via the terminal device, the number of target reference symbols based on a first starting symbol and/or ending symbol.

3. The method according to claim 2, wherein at least one of the following is further comprised:
at least one of the number of first reference symbols, the number of second reference symbols, the first starting symbol, the second starting symbol, the ending symbol, and the number of slot symbols being carried in a sidelink Radio Resource Control (RRC);
the number of first reference symbols being less than or equal to the number of second reference symbols; and
the first starting symbol being earlier than or identical to the second starting symbol.

4. The method according to claim 2, wherein:
the number of first reference symbols is selected from at least one of {7, 8, 9, 10, 11, 12, 13, 14}; and/or
the number of second reference symbols is selected from at least one of {7, 8, 9, 10, 11, 12, 13, 14}; and/or
the first starting symbol is selected from at least one of {0, 1, 2, 3, 4, 5, 6}; and/or
the second starting symbol is selected from at least one of {3, 4, 5, 6, 7}.

5. The method according to claim 1, further comprising:
determining the transport block size, and/or
wherein the determining the transport block size comprises at least one of the following:
determining the transport block size based on the number of target reference symbols;
when a terminal device attempts to transmit Physical Sidelink Shared Channel (PSSCH) outside the COT, determining the transport block size based on a number of first reference symbols, a number of subcarriers in a resource block, a Physical Sidelink Feedback Channel (PSFCH) overhead indicator, the Sidelink Demodulation Reference Signals (SL DMRS) overhead, the number of resource elements occupied by PSCCH and PSCCH DMRS, a number of coded modulation symbols used for two-stage Sidelink Control Information (SCI) transmission, Sidelink Channel State Information Reference Signals (SL-CSI-RS) overhead, and Sidelink Phase Tracking Reference Signals (SL-PT-RS) overhead configured by a network device;
when a terminal device attempts to transmit the PSSCH within the COT, determining the transport block size based on a number of second reference symbols, a number of subcarriers in a resource block, the SL DMRS overhead, the number of resource elements occupied by PSCCH and PSCCH DMRS, a number of coded modulation symbols used for two-stage SCI transmission, the PSFCH overhead indicator, the SL-CSI-RS overhead, and the SL-PT-RS overhead configured by the network device;
when a terminal device attempts to receive the PSSCH outside the COT, determining the transport block size based on the number of first reference symbols indicated by SCI and/or the PSFCH overhead indicator, the SL-CSI-RS overhead, and the SL-PT-RS overhead configured by the network device; and
when a terminal device attempts to receive the PSSCH within the COT, determining the transport block size based on a number of sidelink slot symbols, the PSFCH overhead indicator, the SL-CSI-RS overhead, and the SL-PT-RS overhead configured by the network device.

6. The method according to claim 5, wherein:
a PSFCH overhead indicator is carried by SCI format and is used to indicate the number of PSFCH symbols in a sidelink slot; and/or
when a higher-layer parameter configures PSFCH period to 2 or 4, if SCI format indicates presence of PSFCH overhead, the number of PSFCH symbols in a sidelink slot is equal to 3; and/or if SCI format indicates absence of PSFCH overhead, the number of PSFCH symbols in a sidelink slot is equal to 0; and/or
when a higher-layer parameter configures PSFCH period to 1, the number of symbols occupied by the PSFCH is equal to 3; and/or
when a higher-layer parameter configures PSFCH period to 0, the number of symbols occupied by the PSFCH is equal to 0.

7. The method according to claim 1, further comprising:
calculating a temporary number of information bits based on the number of available resource elements, a number of layers, and a modulation order and code rate determined by the MCS; and/or
determining whether the transport block size is obtained through table look-up or formula calculation based on a comparison of the temporary number of information bits with a threshold.

8. A processing method, comprising:
transmitting configuration information, and enabling a terminal device to determine a number of target reference symbols based on the configuration information, wherein the number of target reference symbols is configured to determine a transport block size.

9. The method according to claim 8, wherein the terminal device determining the number of target reference symbols based on the configuration information comprises at least one of the following:
when the transmission occurs outside a COT, selecting, via the terminal device, a number of first reference symbols as the number of target reference symbols;
when the transmission occurs within the COT, selecting, via the terminal device, a number of second reference symbols as the number of target reference symbols;
when the transmission occurs outside the COT, determining, via the terminal device, the number of target reference symbols based on a second starting symbol and/or ending symbol; and
when the transmission occurs within the COT, determining, via the terminal device, the number of target reference symbols based on a first starting symbol and/or ending symbol.

10. The method according to claim 9, wherein at least one of the following is further comprised:
at least one of the number of first reference symbols, the number of second reference symbols, the first starting symbol, the second starting symbol, the ending symbol, and the number of slot symbols being carried in a sidelink RRC;
the number of first reference symbols being less than or equal to the number of second reference symbols; and
the first starting symbol being earlier than or identical to the second starting symbol.

11. The method according to claim 9, wherein:
the number of first reference symbols is selected from at least one of {7, 8, 9, 10, 11, 12, 13, 14}; and/or
the number of second reference symbols is selected from at least one of {7, 8, 9, 10, 11, 12, 13, 14}; and/or
the first starting symbol is selected from at least one of {0, 1, 2, 3, 4, 5, 6}; and/or
the second starting symbol is selected from at least one of {3, 4, 5, 6, 7}.

12. The method according to claim 10, wherein the configuration information is transmitted by a network device or a transmitting device; and/or
the configuration information comprises at least one of the following: at least two sets of number of reference symbols, a number of first reference symbols, a number of second reference symbols, a first starting symbol, a second starting symbol, an ending symbol, and the number of slot symbols.

13. A communications device, comprising: a memory, a processor, and a processing program stored in the memory and executable on the processor, wherein the processing program, when executed by the processor, implements the processing method according to claim 1.

14. A communications device, comprising: a memory, a processor, and a processing program stored in the memory and executable on the processor, wherein the processing program, when executed by the processor, implements the processing method according to claim 10.

15. A non-transitory computer-readable storage medium, wherein the non-transitory computer-readable storage medium stores a computer program, and the computer program, when executed by a processor, implements the processing method according to claim 1.

16. A non-transitory computer-readable storage medium, wherein the non-transitory computer-readable storage medium stores a computer program, and the computer program, when executed by a processor, implements the processing method according to claim 10.
